(19) United States
(12) Patent Application Publication
(10) Pub. No.: US 2017/0326769 A1
(43) Pub. Date: Nov. 16, 2017

(54) RESIN MOLDED BODY

(71) Applicant: CENTURY INNOVATION CORPORATION, Tokyo (JP)

(72) Inventor: Hiroaki KAWASAKI, Tokyo (JP)

(73) Assignee: Century Innovation Corporation, Tokyo (JP)

(21) Appl. No.: 15/529,806

(22) PCT Filed: Dec. 4, 2015
(86) PCT No.: PCT/JP2015/084131

§ 371 Date: May 25, 2017

(30) Foreign Application Priority Data
Dec. 5, 2014 (JP) 2014-246628

(51) Int. Cl. B29C 45/62; B29C 45/53; B29C 45/00; B29K 509/08; B29K 23/00

(52) U.S. Cl. CPC B29C 45/62; B29C 45/53; B29C 45/0001; B29K 2023/12; B29K 2995/0039; B29K 2995/0041; B29K 2509/08

(57) ABSTRACT

It is an object of the present invention to provide a resin molded body capable of appropriately and easily improving strength compared to the prior art. The resin molded body according to the present invention includes first phases (21, 24) in which convex and concave parts extend in substantially linear directions (D, E), observed within a measurement range (A) of 5 μm×5 μm arbitrarily selected on a resin cross section and the first phases account for 50% or more. The first phases are preferably in a crystalline state. A second phase made of an amorphous substance (25) is preferably interposed between the first phases.

### TECHNICAL FIELD

The present invention relates to a resin molded body with excellent crystallinity.

### BACKGROUND ART

The following Patent Literature 1 discloses an invention relating to a resin molded body with excellent insulating property, heat resistance and mechanical strength, and a manufacturing method therefore.

According to Patent Literature 1, a resin molded body is formed of a resin composition of base resin and a thermal conductive filler contained therein. Furthermore, a glass filler is further added to improve mechanical strength.

### CITATION LIST

### Patent Literature

Patent Literature 1

Japanese Patent Application Laid-Open No.2008-184540

### SUMMARY OF INVENTION

### Technical Problem

However, according to the technique described in Patent Literature 1, it is necessary to adjust the amount of filler added by also taking into account characteristics other than affinity between the resin and the glass filler, and strength. Moreover, a filler for improving strength is also necessary, which leads to an increase in production cost as well. Patent Literature 1 does not particularly refer to a state of material inside the resin molded body. No particular reference is made to the shape of the filler when the filler is mixed with the resin, either.

The present invention has been implemented in view of such problems and it is an object of the present invention to provide a resin molded body capable of improving crystallinity and increasing strength.

### Solution to Problem

As a result of intensive researches to attain the above-described object, the present inventor discovered that it is possible, for example, to form a resin molded body with higher crystallinity than that in the prior art by using an injection apparatus of the present invention and increase its strength to complete the present invention. That is, the present invention is as follows.

A resin molded body according to the present invention includes first phases in which convex and concave parts extend in a substantially linear direction, observed within a measurement range of 5 μm×5 μm arbitrarily selected on a resin cross section, in which the first phases account for 50% or more. Thus, the regularly arrayed first phases account for 50% or more of the area within the measurement range, and it is thereby possible to increase crystallinity of the resin molded body. This makes it easier to obtain a resin molded body with greater strength. For example, the resin molded body of the present invention can be used as a joined body of different members, and joining strength of the joined body can be effectively increased.

In the present invention, the first phases preferably account for 70% or more. This makes it possible to more effectively increase crystallinity of the resin molded body.

In the present invention, the first phases are preferably in a crystalline state. In the first phases, high polymers are regularly arrayed, exhibiting a high degree of crystallinity, which makes it possible to effectively improve crystallinity.

In the present invention, a second phase made of an amorphous substance is preferably interposed between the first phases. Thus, since the amorphous second phase is interposed between the regularly arrayed first phases, it is possible to prevent the generation of a grain boundary and effectively increase strength.

In the present invention, the measurement range is preferably set substantially at the center of the resin cross section.

Furthermore, the present invention provides a resin molded body including resin and a filler, in which the filler in a long linear shape is observed within a measurement range of 500 μm×500 μm arbitrarily selected on the resin surface or on a resin cross section.

Furthermore, the resin cross section is preferably observed using a laser microscope.

In the present invention, molding is preferably performed using an injection apparatus that incorporates a melter that includes a through hole, one opening of which is an inflow port of the injection material, the other opening of which is an outflow port of the injection material, and an inner wall surface of the through hole is formed of an inclined surface so that the opening becomes narrower from the inflow port to the outflow port of the through hole. In this case, the resin molded body is molded more preferably using the injection apparatus that incorporates the melter in which an inclined surface which is continuous to the inclined surface and has a gentler slope than the inclined surface is formed on the inflow port side.

Using the injection apparatus according to the present invention, it is possible to increase melting efficiency, obtain a resin molded body without applying a large pressure, and easily obtain a resin molded body in which regularly arrayed first phases are observed in 50% or more of a measurement range of 5 μm×5 μm.

### Advantageous Effects of Invention

The resin molded body according to the present invention can improve crystallinity. This makes it easier to obtain a higher strength resin molded body. Therefore, when the resin molded body of the present invention is used as, for example, a joined body of different members, it is possible to effectively increase joining strength of the joined body.

### BRIEF DESCRIPTION OF DRAWINGS

FIG. 1 is a longitudinal cross-sectional view illustrating a resin molded body according to the present embodiment;

FIG. 2 is a longitudinal cross-sectional view of a connection structure using the resin molded body of the present embodiment;

FIG. 3 is a longitudinal cross-sectional view of a connection structure having a structure different from that in FIG. 2 using the resin molded body of the present embodiment;

FIG. 4 is a perspective view for describing a method of analyzing a state of material inside the resin molded body of the present embodiment;

FIG. 5 is a schematic view for describing the state of material observed inside the resin molded body of the present embodiment;

FIG. 6 is a schematic cross-sectional view of an injection apparatus according to the present embodiment;

FIG. 7 is a schematic cross-sectional view of the injection apparatus illustrating a state in which resin pellets are supplied to the injection apparatus shown in FIG. 6;

FIG. 8 is a schematic cross-sectional view for describing a molding step of a connection structure using the injection apparatus according to the present embodiment;

FIG. 9 is a longitudinal cross-sectional view of a melter according to the present embodiment;

FIG. 10 is a longitudinal cross-sectional view of a melter according to an embodiment different from that in FIG. 9;

FIG. 11 is a schematic cross-sectional view of an injection apparatus according to an embodiment different from that in FIG. 6, illustrating a state in which resin pellets are supplied;

FIG. 12 is a schematic cross-sectional view of the injection apparatus illustrating a state in which the melter which can move in a vertical direction (reciprocating movement) is caused to move upward from the state in FIG. 11;

FIG. 13 is a schematic cross-sectional view for describing a molding step of the connection structure when the melter is caused to move downward from the state in FIG. 12;

FIG. 14 is a laser micrograph of example 1 picked up at a magnification of 15000×;

FIG. 15 is a schematic view within the measurement range shown in FIG. 14;

FIG. 16 is a laser micrograph of comparative example 1 picked up at a magnification of 15000×;

FIG. 17 is a schematic view within the measurement range shown in FIG. 16;

FIG. 18 is a laser micrograph of example 2 picked up at a magnification of 15000×;

FIG. 19 is a laser micrograph of comparative example 2 picked up at a magnification of 15000×;

FIG. 20 is a laser micrograph of example 3 picked up at a magnification of 15000×;

FIG. 21 is a 3D photograph of the laser micrograph in FIG. 20;

FIG. 22 is a partial schematic view illustrating part of the 3D photograph shown in FIG. 21;

FIG. 23 is a laser micrograph of comparative example 3 picked up at a magnification of 15000×;

FIG. 24 is a 3D photograph of the laser micrograph in FIG. 23;

FIG. 25 is a partial schematic view illustrating part of the 3D photograph shown in FIG. 24;

FIG. 26 is a laser micrograph of a surface of a molded body of comparative example 4;

FIG. 27 is a schematic view illustrating part of FIG. 26;

FIG. 28 is a laser micrograph of a surface of a molded body of example 4;

FIG. 29 is a schematic view illustrating part of FIG. 28;

FIG. 30 is a laser micrograph of a longitudinal cross section of comparative example 5;

FIG. 31 is a schematic view illustrating part of FIG. 30;

FIG. 32 is a laser micrograph of a longitudinal cross section of comparative example 6;

FIG. 33 is a schematic view illustrating part of FIG. 32;

FIG. 34 is a laser micrograph of a longitudinal cross section of example 5;

FIG. 35 is a schematic view illustrating part of FIG. 34;

FIG. 36 is a laser micrograph of a longitudinal cross section of example 6;

FIG. 37 is a schematic view illustrating part of FIG. 36; and

FIG. 38 is a schematic view for describing a cutting direction of the resin molded body used for the experiment.

### DESCRIPTION OF EMBODIMENT

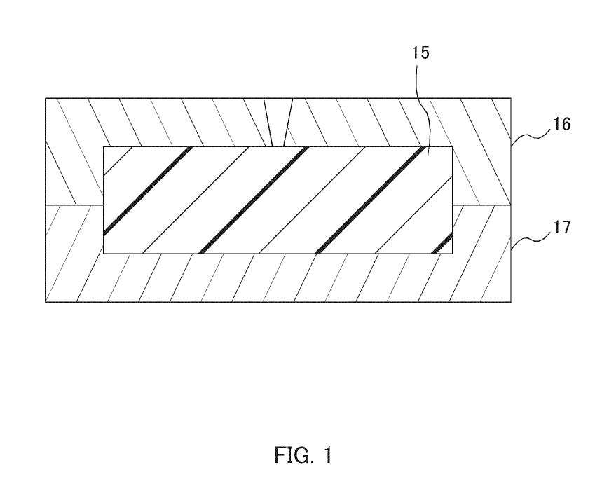

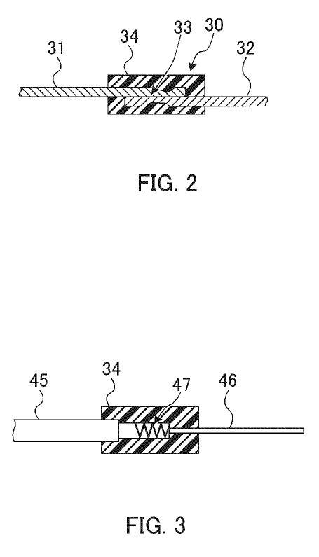

Hereinafter, an embodiment of the present invention will be described in detail with reference to the accompanying drawings. FIG. 1 is a longitudinal cross-sectional view illustrating a resin molded body according to the present embodiment. FIG. 2 is a longitudinal cross-sectional view of a connection structure using the resin molded body of the present embodiment. FIG. 3 is a longitudinal cross-sectional view of a connection structure having a structure different from that in FIG. 2 using the resin molded body of the present embodiment. Note that in the present DESCRIPTION, a “longitudinal cross section” refers to a cross section cut along a height direction orthogonal to a horizontal plane, a cross section cut along an axial direction of a drive transmission shaft 9 of an injection apparatus 1 or a cross section cut along a flow direction (injection direction) of resin from a nozzle part of the injection apparatus.

As shown in FIG. 1, a resin molded body 15 is manufactured by injecting molten resin into an upper mold 16 and a lower mold 17 of a metal die. A connection structure 30 shown in FIG. 2 is configured with a plurality of conductive members 31 and 32, a connection part 33 where the conductive members 31 and 32 are electrically connected, and a resin molded body 34 in which the connection part 33 is embedded. Furthermore, in FIG. 3, conductive members 45 and 46 of different types are electrically connected. For example, the conductive member 45 is a vinyl-coated electric wire and the conductive member 46 is an enamel wire. Conductors are exposed at distal ends of the conductive members 45 and 46, and the conductive members 45 and 46 are electrically connected together by soldering the conductors of the respective conductive members 45 and 46. A connection part 47 is formed in this way. The connection part 47 is then embedded in the resin molded body 34 to thereby secure electrical insulating properties of the connection part 47 from the outside. Thus, the connection structure according to the present embodiment can electrically connect conductive members of the same type, and can also electrically connect conductive members of different types.

The resin molded bodies 15 and 34 shown in FIG. 1, FIG. 2 and FIG. 3 are molded in required sizes as appropriate, and therefore while their sizes are not limited, the resin molded bodies can be molded in small sizes according to the present embodiment; their widths, lengths and heights can be as small as, for example, several mm to several cm.

The material of the resin molded bodies 15 and 34 is not limited, but the resin molded bodies 15 and 34 are preferably formed of thermoplastic resin. The material used as the resin molded body 34 used for the connection structure in particular preferably has high electrical insulating properties and excellent heat resistance. Examples of the material of the resin molded bodies 15 and 34 include polypropylene (PP), polycarbonate (PC), polyacetal (POM), polybutylene terephthalate (PBT), polyphenylene sulfide (PPS), polyether ether ketone (PEEK), liquid crystal polymer (LCP), and polyethylene (PE). The resin molded bodies 15 and 34 of the present embodiment are preferably plastic injection molded bodies. Plastics is solid artificially made mainly of polymer or ultra-high polymer. The present embodiment can perform molding while preventing any deteriorated substance from mixing into the injection molded product. In the present embodiment in particular, it is possible to mold an injection molded product using polyether ether ketone (PEEK).

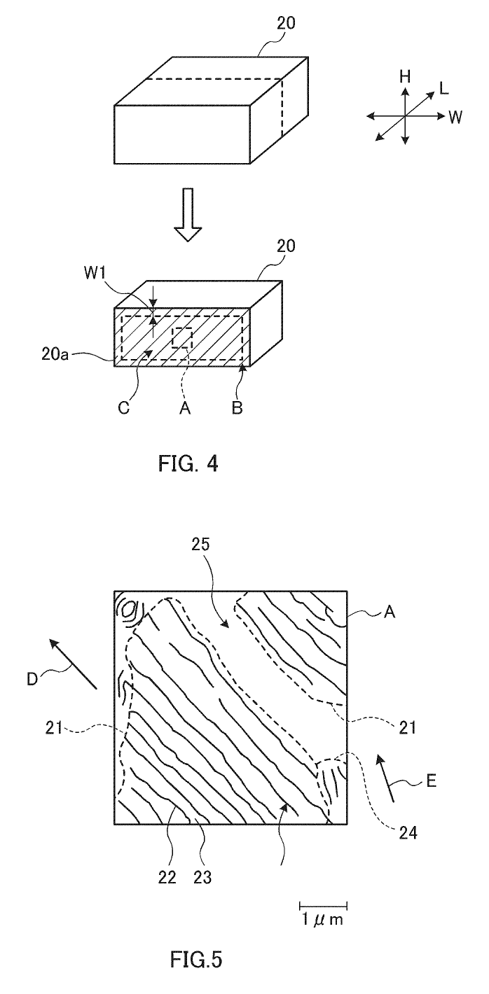

FIG. 4 is a perspective view for describing a method of analyzing a state of material inside the resin molded body of the present embodiment.

As shown in the upper drawing in FIG. 4, a resin molded body 20 is cut along a dotted line shown in FIG. 4. The cutting method is not particularly limited, but a cutting machine, cutter, punching device, water cutter can be taken as examples.

Cutting positions of the resin molded body 20 are not particularly limited, but as shown in the upper drawing in FIG. 4, the resin molded body 20 may be cut along a width direction W toward a height direction H or cut along a length direction L toward the height direction H or cut along a width direction W toward the length direction L. Alternatively, the resin molded body 20 may also be cut diagonally. Thus, the cutting position or cutting direction is not defined. Note that the respective directions W, L and H are orthogonal to each other. As shown in the upper drawing in FIG. 4, when the resin molded body 20 is cut along the width direction W toward the height direction H, the resin molded body 20 is suitably cut such that the cutting line passes through substantially the center in the length direction L, that is, the resin molded body is cut into two portions from near the center. However, when an attempt is made to cut the resin molded body 20 into two portions from near the center, if the cutting position is preferably shifted because a member that cannot be divided is located near the center or for other reasons, the cutting position can be changed as appropriate.

The lower drawing in FIG. 4 illustrates one of the portions obtained by cutting the resin molded body 20 shown in the upper drawing in FIG. 4. The shaded part shown in the lower drawing in FIG. 4 is a resin cross section (cut surface) 20a. In the present embodiment, a range of 5 μm×5 μm arbitrarily selected from within the resin cross section 20a is defined as a measurement range A to observe a state of material. The measurement range A of 5 μm×5 μm is defined because if the size is smaller than this, it is difficult to observe/analyze the state of material. On the other hand, if the measurement range A is too wide, the observation/analysis time becomes longer. Therefore, the measurement range A of 5 μm×5 μm is defined to make it possible to set the time required for an observation or analysis to an appropriate time length and obtain an accurate analysis result.

Here, the expression “arbitrarily selected” refers to a state in which an observer can select the measurement range A appropriately and it would be sufficient that at least any one measurement range A include the state of material which is a characteristic part of the present embodiment, which will be described later. Thus, in the present embodiment, although the position of the measurement range A within the resin cross section 20a is not limited, in an end region B located outside the resin cross section 20a, it may be difficult to obtain an accurate state of material due to external influences or the like, and it is therefore preferable to determine the measurement range A using a region C more inside than the end region B. Here, a width W1 of the end region B is preferably on the order of 1/10 to ¼ of the width of the resin cross section 20a. Furthermore, it is preferable to set the measurement range A more inside of the inside region C, and as shown in the lower drawing in FIG. 4, the measurement range A is preferably set substantially at the center of the resin cross section 20a. “Substantially at the center” indicates a wide range including the center and its surroundings.

FIG. 5 is a schematic view for describing the state of material observed in the resin molded body of the present embodiment. Examples of the technique of observing the resin cross section 20a include a laser microscope (optical microscope: LSM), scanning electron microscope (SEM), transmission electron microscope (TEM) and scanning type probe microscope (SPM). Among them, the laser microscope is preferably used. The schematic view shown in FIG. 5 schematically illustrates an image of the measurement range A shown in the lower drawing in FIG. 4 picked up by a laser microscope.

Within the measurement range A of 5 μm×5 μm shown in FIG. 5, a first phase 21 is observed in which convex and concave parts extend in a substantially linear direction D. In FIG. 5, the first phase 21 is enclosed by a dotted line. As shown in FIG. 5, in the first phase 21, a plurality of convex parts are formed along the substantially linear direction D. A concave part 23 is interposed between the convex parts 22 and a plurality of concave parts 23 are also formed along the substantially linear direction D. In this way, the plurality of convex parts 22 and the plurality of concave parts 23 extend in the substantially linear direction D, and each convex part 22 and each concave part 23 are alternately arrayed in a direction orthogonal to the substantially linear direction D. FIG. 5 shows the convex part 22 using a thin line, but the convex part 22 actually has a width. Here, the “substantially linear direction” need not exactly be a linear direction, but even when there are certain twists and turns, if the directions in which the plurality of convex parts 22 and concave parts 23 extend are substantially uniform, it is defined that convex and concave parts extend in the substantially linear direction D. For example, if the convex part 22 extends within a band that extends linearly in a width approximately three times the width of the convex part 22, it is defined that convex and concave parts extend in the substantially linear direction although the convex part 22 has twists and turns within the width.

As shown in FIG. 5, within the measurement range A of 5 μm×5 μm, a first phase 24 may be formed in which convex and concave parts extend in an E direction instead of the D direction as the substantially linear direction. That is, the substantially linear direction referred to in the present embodiment is not limited to a one direction but may be a plurality of directions.

An aspect ratio (longitudinal length/horizontal width) of the convex part 22 or concave part 23 making up the first phase 21 or 24 is preferably 10 or more. If the aspect ratio is too small, even if the convex part 22 or concave part 23 seems to constitute the first phase, part of an amorphous substance may only happen to look like that, and long molecules are simply appropriately folded and repeat that folding, but this does not mean that a structure with a regular array is configured, and the crystalline state is not formed appropriately. Therefore, the aspect ratio (longitudinal length/horizontal width) of the convex part 22 or concave part 23 making up the first phase 21 or 24 is set to 10 or more. In other words, it is possible to define a region having an aspect ratio of 10 or more as the first phase and not to regard a region having an aspect ratio less than 10 as the first phase.

The first phases 21 and 24 are preferably in a crystalline state. The degree of crystallinity can be measured using, for example, an X-ray diffraction analysis, but the degree of crystallinity is higher in the first phase 21 or 24 than phases (such as a second phase 25 which will be described later) other than and peripheral to the first phase. As described above, the first phases 21 and 24 are regularly arrayed phases, in other words, the first phases 21 and 24 constitute a crystalline state in which high polymers are regularly arrayed. Note that the “crystalline state” refers not only to a perfect crystal phase but also to a state in which there is a high degree of crystallinity as described above and an amorphous substance may partially be mixed. However, the crystal part has a higher ratio than the amorphous part.

Furthermore, as shown in FIG. 5, a second phase 25 made of an amorphous substance is interposed between the first phases 21. Note that the second phase 25 may not be observed within the measurement range A. The second phase 25 is a region where the degree of crystallinity is lower than the first phase 21 or 24.

According to the present embodiment, the first phases 21 and 24 observed within the arbitrarily selected measurement range A of 5 μm×5 μm accounts for 50% or more of the area range. Since the regularly arrayed first phases 21 and 24 occupy a wide area in this way, it is possible to increase the degree of crystallinity of the resin molded body 20. With a higher degree of crystallinity, an improvement of strength can also be expected. For example, strength may be mechanical strength such as tensile strength, bending strength, impact strength, cutting strength, and a resin molded body according to the example of the present embodiment which will be described later is more difficult to cut than the resin molded body of a comparative example (first phase occupies less than 50%). Therefore, it has been found that the resin molded body according to the example of the embodiment has greater cutting strength than the resin molded body of the comparative example. In the present embodiment, the resin molded body 34 can be used as a joined body of different members as shown in FIG. 2 and FIG. 3 and can effectively increase joining strength of the joined body.

In the present embodiment, the first phases 21 and 24 preferably account for 70% or more within the measurement range A. It is possible to more effectively increase crystallinity of the resin molded body, and eventually increase strength of the resin molded body. The ratio of the first phases 21 and 24 to the measurement range A is more preferably 80% or more.

The first phases 21 and 24 are preferably in a crystalline state. The first phases 21 and 24 are regularly arrayed and this is considered to be attributable to the fact that the first phases 21 and 24 are in a crystalline state. Furthermore, the crystalline state can be grasped using an X-ray diffraction analysis.

Furthermore, as shown in FIG. 5, a second phase 25 made of an amorphous substance is preferably interposed between the first phases 21. With the second phase 25 (amorphous phase) being interposed between the first phases 21, it is possible to more effectively increase strength of the resin molded body without generating any grain boundary.

In the present embodiment, a filler may be contained in the resin molded body. However, the filler content is restricted so that the area range of the first phase in the measurement range A can be kept to 50% or more.

In the present embodiment, the resin molded body 15, 20 or 34 shown in FIG. 1 to FIG. 4 can be molded using the injection apparatus incorporating a melter shown below.

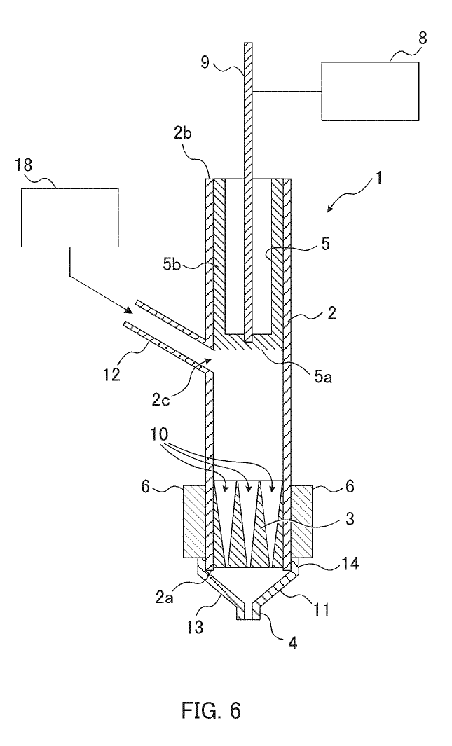

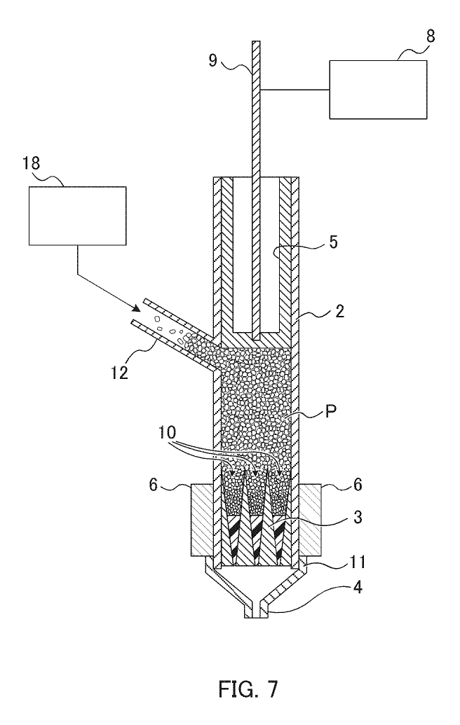

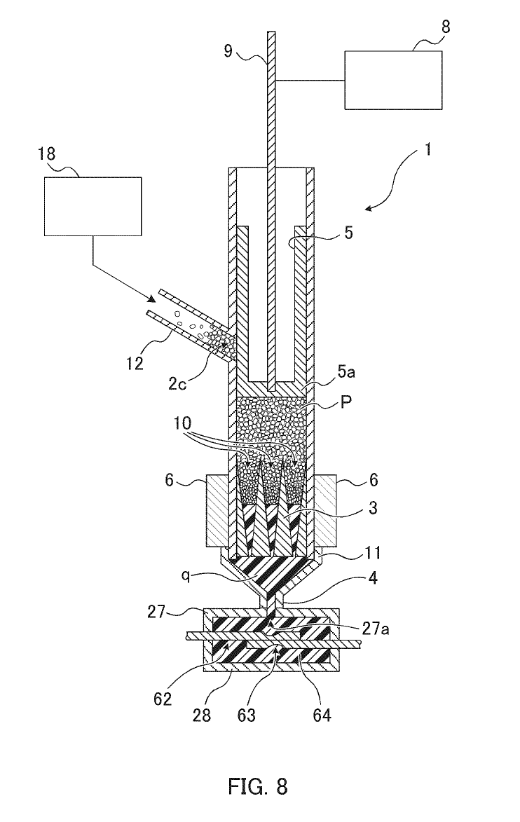

FIG. 6 is a schematic cross-sectional view of the injection apparatus according to the present embodiment. FIG. 7 is a schematic cross-sectional view of the injection apparatus illustrating a state in which resin pellets are supplied to the injection apparatus shown in FIG. 6. FIG. 8 is a schematic cross-sectional view for describing a molding step of a connection structure using the injection apparatus according to the present embodiment.

The injection apparatus 1 includes a cylinder 2, a melter 3 disposed in the cylinder 2, a nozzle part 4 disposed at a distal end of the injection apparatus 1, heating means 6 for heating the melter 3, and pressurizing means for pressurizing molten resin and ejecting the molten resin from the nozzle part 4 to the outside.

The melter 3 shown in FIG. 6 is fixed inside the cylinder 2. The melter 3 is disposed on a distal end 2a side (lower side in FIG. 6) of the cylinder 2. A plunger 5 is provided inside the cylinder 2 as pressurizing means. In FIG. 6, the plunger 5 is disposed closer to a rear end 2b side (upper side in FIG. 6) of the cylinder 2 than the melter 3. As shown in FIG. 6, a predetermined interval is provided between the melter 3 and the plunger 5. The plunger 5 is supported so as to be movable upward/downward (reciprocating movement) by drive means. The upward/downward movable plunger 5 is located at a position most retracted in a rear end direction of the cylinder 2 in FIG. 6 and FIG. 7, and FIG. 8 illustrates a state in which the plunger 5 has moved toward a distal end direction of the cylinder 2 from the state in FIG. 7.

The cylinder 2 is formed into an elongated cylindrical shape having substantially fixed inner and outer diameters from the distal end 2a to the rear end 2b, but its shape is not particularly limited. That is, the shape of the cylinder 2 is not particularly limited as long as the cylinder 2 is configured to be able to fix the melter 3 in the cylinder 2 and move the plunger 5 upward/downward as the pressurizing means. For example, the cylinder 2 may have a square shape whose interior is hollow.

Although the material of the cylinder 2 is not particularly limited, it is suitable to use iron or stainless steel with a high content of iron because of the necessity for rapid heating.

As shown in FIG. 6, the cylinder 2 is provided with a pellet supply port 2c. The pellet supply port 2c is shaped like a hole that communicates with a space inside the cylinder so as to be located between the melter 3 fixed on the distal end 2a side of the cylinder 2 and the plunger 5 retreated toward the rear end 2b direction of the cylinder 2 (upward direction in the drawing). A tubular supply pipe 12 is connected to the pellet supply port 2c.

A top end of the supply pipe 12 communicates with a storage part 18 that stores many resin pellets (injection material) and resin pellets are supplied from the storage part 18 to the pellet supply port 2c via the supply pipe 12. The storage part 18 is, for example, a hopper. The storage part 18 is provided with a screw conveyance or pneumatic apparatus, and can also forcibly charge resin pellets into the supply pipe 12. Note that without providing any storage part, resin pellets may also be supplied through a pipe from a remote place through screw conveyance or pneumatic transportation.

The plunger 5 is constructed of a pressing part 5a and a cylindrical outer circumferential side face part 5b provided around the pressing part 5a and formed toward the rear end 2b direction of the cylinder 2. As shown in FIG. 6, the size of the pressing part 5a coincides with the inner diameter of the cylinder 2 and a spatial region of the cylinder 2 from the pressing part 5a to the rear end 2b of the cylinder 2 is closed with the plunger 5. Note that rigid heat-resistant synthetic resin is fixed to the front face of the pressing part 5a (undersurface side in the drawing) as needed. This makes it possible to thermally insulate the melter 3 from the plunger 5 to prevent the plunger 5 from depriving the melter 3 of heat and prevent the plunger 5 from becoming hot so as to transmit heat to a drive section 8.

The plunger 5 is connected to the drive section 8 and the plunger 5 is supported so as to be movable in the vertical direction (reciprocating movement) inside the cylinder 2 by a drive force of the drive section 8. Note that as shown in FIG. 6, a drive transmission shaft (rod) 9 is disposed between the drive section 8 and the plunger 5, and the drive section 8 and the drive transmission shaft 9 together constitute “drive means.” For example, the drive section 8 is a motor drive section and the drive transmission shaft 9 is a rack shaft, a pinion gear (not shown) is disposed between the motor drive section and the rack shaft, and the drive means is constructed of the motor drive section, the rack shaft and the pinion gear. Note that the cross-sectional shape of the drive transmission shaft (rod) 9 is, for example, circular, but the shape is not limited.

As shown in FIG. 6, the heating means 6 for heating the melter 3 is provided around an outer circumference of the cylinder 2. Thus, the heating means 6 is a component to heat the melter 3 from the outer circumferential surface of the cylinder 2 and is preferably formed to be cylindrical so that thermal conductivity to the melter 3 improves. The heating means 6 is provided at a position facing the melter 3 (so as to surround an outer circumference of the melter 3).

For example, the heating means 6 is made up of an IH heater or the like configured into a winding shape. To be more specific, the heating means 6 is preferably an electromagnetic induction apparatus, that is, IH (induction heating) coil, and is an IH coil wound around a resin or ceramic heat insulating material coil bobbin. Note that, instead of using the bobbin, both ends of the heating means 6 may be held by a holder of a heat insulating material. Furthermore, a band heater may also be used as another type of the heating means 6. Furthermore, the heating means 6 is not limited to the above-described one, but any means may be used if it is another heating apparatus available to the present invention. Note that the cylinder 2 is preferably provided with a thermocouple so as to be able to adjust the temperature of the cylinder 2 to a set value.

Although details of the melter 3 will be described later, the melter 3 is provided with a plurality of through holes (melting holes) 10 in the height direction. The shape of the outer circumferential surface of the melter 3 matches the shape of the inner wall surface of the cylinder 2 so that the entire outer circumferential surface of the melter 3 comes into contact with the inner wall surface of the cylinder 2. Therefore, if the inner wall surface (hollow part) of the cylinder 2 is shaped like a column, the outer circumferential surface of the melter 3 is also shaped like a column having the same diameter.

As shown in FIG. 6, an opening on the top surface side of the melter 3 of each through hole 10 is an inflow port and an opening on the undersurface side of the melter 3 of each through hole 10 is an outflow port.

As the material of the melter 3, metal which has a large heat capacity and excellent heat conduction or excellent heat-resistance is suitable. To be more specific, copper, beryllium copper, brass, stainless steel, gold, chromium steel, nickel chromium steel, molybdenum steel, tungsten steel or the like is used, but the material is not particularly limited. Forming the melter 3 to a size, which will be described later, can effectively suppress unmelted residues of the resin pellets P (injection material).

As shown in FIG. 6, a head part 11 provided with the nozzle part 4 is provided at the distal end 2a of the cylinder 2. The head part 11 is constructed of the nozzle part 4, a funnel part 13 and a connection part 14. The head part 11 is connected to the cylinder 2 via the connection part 14. A material with good heat conduction is suitable for the head part 11 and, to be more specific, brass, beryllium copper or copper is preferable.

As shown in FIG. 7, many solid resin pellets (injection material) P are supplied from the storage part 18 into the cylinder 2 via the supply pipe 12.

Although the material of the resin pellets P is not particularly limited, examples of the material of the resin pellets P include polypropylene (PP), polybutylene terephthalate (PBT), polyphenylene sulfide (PPS), polyether ether ketone (PEEK), liquid crystal polymer (LCP), polyethylene (PE). Note that each resin pellet P has a diameter or a length of a long side of on the order of 1 to 1.5 mm.

When the resin pellets P reach an upper part of the melter 3, the resin pellets P enter each through hole (melting hole) of the melter 3 from the inflow port (top surface in the drawing). The resin pellets P which have entered each through hole 10 are pressed by resin pellets P that enter later toward the outflow port side of each through hole 10 (undersurface side in the drawing). In this case, the melter 3 is kept at a temperature at which the resin pellets P are melted via the heating means 6.

As shown in FIG. 7, the resin pellets P that have flown into each through hole 10 are partially softened by heat from the melter 3.

As shown in FIG. 8, the drive means is driven to drive the plunger 5 as the pressurizing means toward the direction of the nozzle part 4 (downward direction in the drawing). This causes all the many resin pellets P located between the inflow port side face of the melter 3 (top surface in the drawing) and the undersurface of the pressing part 5a of the plunger 5 to be pressed against each other. As shown in FIG. 8, the pellet supply port 2c is closed with the plunger 5 due to the downward movement of the plunger 5.

As the plunger 5 moves, the resin pellets P that have flown into each through hole 10 of the melter 3 are also pressurized. Thus, the resin pellets P are pressurized and brought into an airtight state in each through hole 10, further melted by heat from the melter 3 and molten resin q flows from the outflow port (undersurface side) of the melter 3 into the head part 11. The molten resin q is pressurized while being kept in the highly airtight state and ejected to the outside from the nozzle part 4.

In FIG. 8, the nozzle part 4 is located at a supply port 27a of an upper mold 27 that constitutes a molding die and injects the molten resin q into the upper mold 27 and a lower mold 28 of the molding die. The charged molten resin q is then cooled to become solid. An injection time of the molten resin q by the injection apparatus 1 is several hundreds of milliseconds to several seconds (e.g., on the order of one second). As shown in FIG. 8, a conductive joined body 62 obtained by electrically connecting a plurality of conductive members is disposed in advance, surroundings of the conductive joined body 62 can be filled with a resin molded body 64 through the injection of the molten resin q, and this makes it possible to secure electrical insulating properties of the connection part 63 of the conductive joined body 62 from the outside.

Next, the melter 3 according to the present embodiment will be described in detail. As has already been described, the melter 3 is provided with a plurality of through holes 10. The melter 3 is provided with a function for passing the resin pellets P through each through hole 10 and melting the resin pellets P. In this case, if unmelted residues of the resin pellets P are produced, this is likely to cause clogging in the through hole 10. Furthermore, when unmelted residues of the resin pellets P are discharged from the melter 3, this may cause clogging in the nozzle part 4 located on the distal end side of the melter 3 and affect the quality of the inter-member joining body and the resin molded product. For this reason, the melter 3 is required to have a mode capable of effectively preventing unmelted residues of the resin pellets P when generating molten resin.

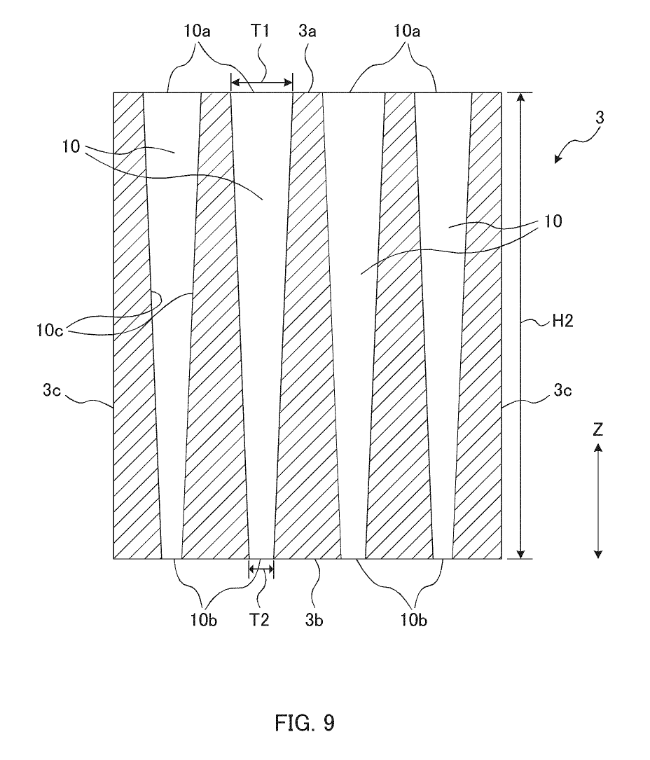

FIG. 9 is a longitudinal cross-sectional view of a melter according to a first embodiment. The melter 3 has a top surface 3a, an undersurface 3b and an outer circumferential surface 3c located between the top surface 3a and the undersurface 3b. The top surface 3a and the undersurface 3b are surfaces facing each other and parallel to each other.

As shown in FIG. 9, a plurality of through holes 10 provided from the top surface 3a to the undersurface 3b (toward the height direction (Z)) are formed in the melter 3. An opening of each through hole 10 in the top surface 3a is an inflow port 10a and an opening in the undersurface 3b is an outflow port 10b.

Although the number of through holes 10 can be set arbitrarily, the number of through holes 10 is preferably plural. Furthermore, the number of through holes 10 may be preferably set so that the ratio of the total area of the inflow ports 10a of the respective through holes 10 to the area of the top surface 3a (inflow port surface) of the melter 3 becomes, for example, 50% or higher.

Although the plurality of through holes 10 may be arranged regularly or randomly, it is possible to increase melting efficiency by uniformly distributing the respective through holes 10 over the entire top surface (inflow port surface) 3a and undersurface (outflow port surface) 3b.

As shown in FIG. 9, an inner wall surface 10c of the through hole 10 is formed of an inclined surface so that the opening gradually becomes narrower from the inflow port 10a to the outflow port 10b in each through hole (melting hole) 10. The respective through holes 10 are preferably formed in a direction parallel to the height direction (Z) from the inflow port 10a to the outflow port 10b. Each through hole 10 is preferably frustum-shaped and to be more specific, truncated cone or truncated pyramid may be presented. In FIG. 9, each through hole 10 has a truncated cone shape.

As shown in FIG. 9, the inflow port 10a of each through hole 10 has an opening width of T1 and the outflow port 10b of each through hole 10 has an opening width of T2. The opening width T1 is greater than the opening width T2. When each through hole 10 has a truncated cone shape, the opening width T1 and the opening width T2 can be calculated as opening diameters. When the through hole 10 has a truncated pyramid shape, the opening width T1 and the opening width T2 represent the widths of the longest straight lines of the sides or diagonals.

In FIG. 9, the opening width T1 is adjusted to within a range of 4.1 mm to 10 mm and the opening width T2 is adjusted to within a range of 1.0 mm to 4.5 mm. In the present specification, the notation “lower limit value to upper limit value” is assumed to include a lower limit value and an upper limit value.

The resin pellets P are caused to flow from the inflow port 10a of each through hole 10 of the melter 3 into the melter 3 shown in FIG. 9, heated, pressurized and melted, and molten resin is caused to flow out from the outflow port 10b of each through hole 10.

As shown in FIG. 9, the inflow port 10a of each through hole 10 is opened greater than the outflow port 10b. For this reason, the resin pellets P can be more easily guided into the inflow port 10a of the through hole 10. Since the opening width T1 of the inflow port 10a is adjusted to within the range of 4.1 mm to 10 mm, it is possible to substantially cover sizes of various resin pellets available on the market and appropriately guide the resin pellets P into the inflow port 10a. Furthermore, the resin pellets P are melted in the melter 3 and discharged to the outside from the outflow port 10b, but since the inner wall surface 10c of the through hole 10 is an inclined surface, it is possible to smoothly guide the molten resin toward the direction of the outflow port 10b and by making the opening width T2 of the outflow port 10b narrower than the opening width T1 of the inflow port 10a, it is possible to increase the heat quantity and extrusion pressure on the outflow port 10b side and cause the molten resin to flow out from the outflow port 10b appropriately. Then, in the embodiment shown in FIG. 9, the opening width T1 of the inflow port 10a is set to 4.1 mm to 10 mm and the opening width T2 of the outflow port 10b is set to 1.0 mm to 4.5 mm. Thus, in the configuration in which the through hole 10 is inclined from the inflow port 10a to the outflow port 10b, by restricting sizes of the respective opening widths of the inflow port 10a and the outflow port 10b to within a predetermined range, it is possible to suppress unmelted residues of resin pellets P compared to the prior arts.

A length H2 from the inflow port 10a to the outflow port 10b of the through hole 10 is preferably 30 mm to 200 mm. The length H2 is defined by the size in a direction parallel to the height direction (Z) from the inflow port 10a to the outflow port 10b. When the length is too small, the melting path from the inflow port to the outflow port becomes shorter, increasing the possibility that unmelted residues of resin pellets P may be generated. On the other hand, when the length of the through hole 10 is too large, the inner wall surface of the through hole 10 becomes closer to a vertical surface than the inclined surface, causing a relative rise in the heat quantity and extrusion pressure on the outflow port 10b side with respect to the inflow port side to be more likely to decrease. In addition, when the length of the through hole 10 is too large, this leads to enlargement in size of the melter 3. The length H2 is more preferably 70 mm to 150 mm.

The present embodiment appropriately adjusts the respective opening widths of the inflow port 10a and the outflow port 10b of the through hole 10 as well as the length of the through hole 10, and can thereby more effectively eliminate unmelted residues of resin pellets P and improve melting efficiency.

In the present embodiment, the opening width T1 of the inflow port 10a is preferably 4.1 mm to 6 mm. Furthermore, the opening width T2 of the outflow port 10b is preferably 1.0 mm to 2.9 mm. The lower limit value of the opening width T2 of the outflow port 10b is more preferably 1.6 mm.

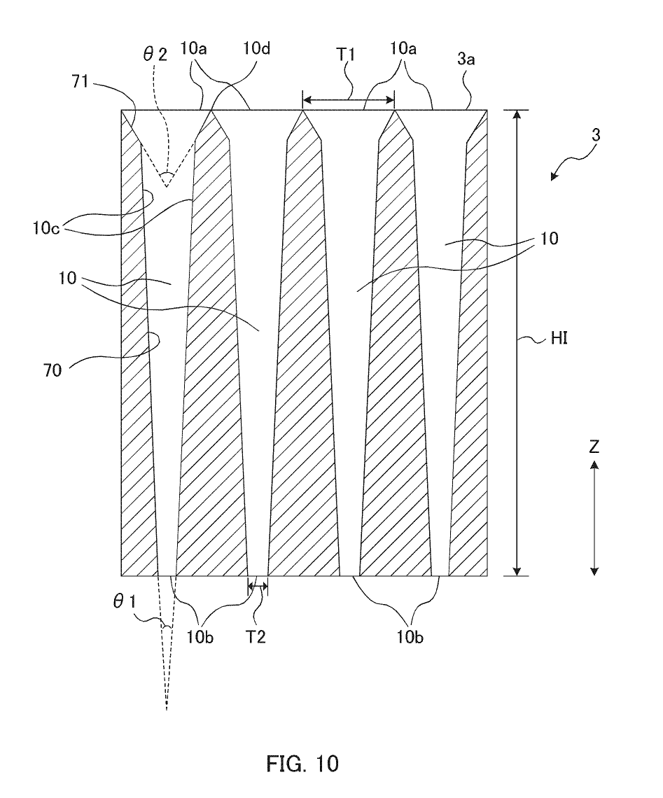

FIG. 10 is a longitudinal cross-sectional view of a melter according to a second embodiment. In the embodiment shown in FIG. 10 as well as in FIG. 9, regarding each through hole (melting hole) 10 making up the melter 3, the inner wall surface 10c of the through hole 10 is formed of an inclined surface in such a way that the opening gradually becomes narrower from the inflow port 10a to the outflow port 10b.

In the embodiment shown in FIG. 10, an inclined surface is formed in continuation to the inclined surface making up each through hole 10 on the inflow port 10a side, the inclined surface having a gentler slope than the inclined surface. To be more specific, each through hole 10 is formed of an inclined surface (first inclined surface) 70 having an opening angle of θ1 and a gentle inclined surface (second inclined surface) 71 having an opening angle of θ2 on the inflow port 10a side. A relationship of θ1<θ2<120° is satisfied. Note that the opening angle θ1 also has a similar opening angle in FIG. 9, and the opening angle θ1 is defined by a relationship between the inflow port 10a and the outflow port 10b.

Here, the “opening angle” refers to an angle formed between mutually facing inclined surfaces in the cross section shown in FIG. 10 and when an angle of inclination of each inclined surface is defined as an angle from the height direction (Z), the opening angle becomes substantially twice the angle of inclination.

As shown in FIG. 10, at points at which neighboring edges 10d of the inflow ports 10a of the through holes 10 come closer to each other and come into contact or nearly come into contact with each other, the edges 10d have a blade shape or blade-like shape, and when the resin pellets P are located on the edges 10d, the resin pellets P are crushed, separated into fine pieces, which further facilitates entries of the resin pellets P into the through hole 10 and suppresses clogging in the through hole 10.

As shown in FIG. 10, the inclined surface 70 having a steep inclination is formed from the outflow port 10b to a position close to the inflow port 10a and the gentle inclined surface 71 having a gentle inclination is formed only in the vicinity of the inflow port 10a.

Note that the inclined surface may be formed so as to have three or more stages. Note that the inclined surface is preferably formed in a two-stage inclination structure in which most of the through hole is formed of the steep inclined surface 70 and the gentle inclined surface 71 is formed only in the vicinity of the inflow port 10a.

As described above, in FIG. 10, the inner wall surface of the through hole 10 is formed of an inclined surface first so that the opening becomes narrower from the inflow port 10a to the outflow port 10b of the through hole 10. Since the opening of the inflow port 10a is greater than that of the outflow port 10b in this way, it is possible to guide the resin pellets P into the inflow port 10a of the through hole 10 more easily. The resin pellets P are melted in the melter 3 and flow out from the outflow port 10b, and since the inner wall surface of the through hole 10 is an inclined surface in this case, the resin pellets P can be smoothly guided toward the outflow port direction, and moreover by making the opening of the outflow port 10b narrower than the opening of the inflow port 10a, it is possible to increase the heat quantity and extrusion pressure on the outflow port side and cause molten resin to flow out from the outflow port 10b appropriately. In the embodiment shown in FIG. 10, the gentle inclined surface 71 is formed on the inflow port 10a side. This further makes it easier to guide the resin pellets P into the inflow port 10a of the through hole 10. It is also possible to prevent flat parts from being formed on the inflow port surface of the melter and form sharp edges between the respective inflow ports (see FIG. 10). Therefore, an effect that the resin pellets P will be fine-cut at the edges 10d of the inflow ports 10a can be expected, and as a result, it is possible to reduce the amount of resin pellets P that remain on the top surface (inflow port surface) 3a of the melter 3.

The present embodiment particularly satisfies a relationship of θ1<θ2<120°. θ2 is preferably 30° to 120°. θ2 is more preferably 30° to 90°. θ2 is further preferably 30° to 60°. Note that the opening angle θ1 is determined by the sizes of the inflow port 10a and the outflow port 10b and is an angle smaller than at least the opening angle θ1. To be more specific, θ1 is on the order of 0° to 20° or on the order of 0° to 10°. When θ2 is smaller than 30°, the difference from the opening angle θ1 becomes smaller, reducing the effect of reducing resin pellets P remaining on the top surface (inflow port surface) 3a of the melter 3 or the fine-cutting effect on the resin pellets P. When the opening angle θ2 becomes greater than at least 120°, the gentle inclined surface 71 on the inflow port side becomes too gentle, causing the resin pellets P to be more easily deposited at some midpoint of the gentle inclined surface on the inflow port side and leading to an increase in size of the melter 3. In contrast, by restricting the opening angle θ2 to within the above-described range as in the case of the present embodiment, it is possible to more effectively improve the melting efficiency while securing a decrease in size of the melter 3.

In the embodiment shown in FIG. 10, it is preferable to adopt the opening widths T1 and T2 of the inflow port 10a and the outflow port 10b shown in FIG. 9. That is, the opening width T1 of the inflow port 10a is 4.1 mm to 10 mm and the opening width T2 of the outflow port 10b is preferably 1.0 mm to 4.5 mm. The opening width T1 of the inflow port 10a is 4.1 mm to 6 mm and the opening width T2 of the outflow port 10b is more preferably 1.0 mm to 2.9 mm. The lower limit value of the opening width T2 is further preferably 1.6 mm.

In the present embodiment, the length H1 from the inflow port 10a to the outflow port 10b of the through hole 10 is preferably 30 mm to 200 mm. The length H1 is more preferably 70 mm to 150 mm.

The melter 3 according to the present embodiment can be configured not only to be used by being fixed in the injection apparatus 1 as shown in FIG. 6 but also to move in the vertical direction (reciprocating movement) through the cylinder as will be described below.

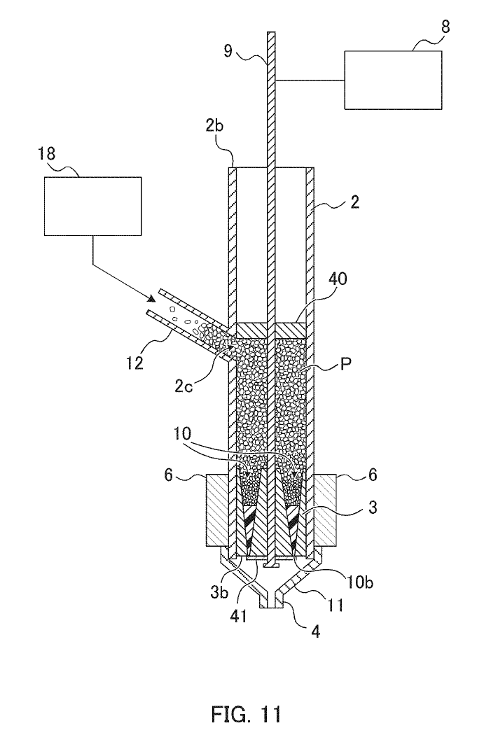

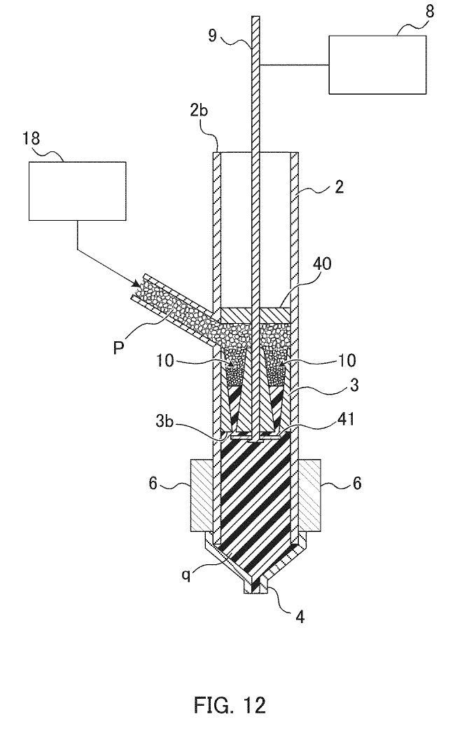

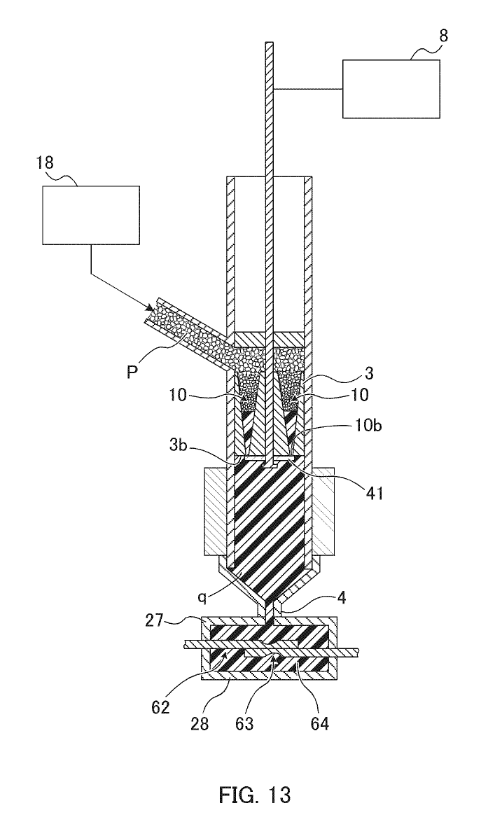

FIG. 11 is a schematic cross-sectional view of an injection apparatus according to an embodiment different from that in FIG. 6, illustrating a state in which resin pellets are supplied. FIG. 12 is a schematic cross-sectional view of the injection apparatus illustrating a state in which the melter which can move in a vertical direction (reciprocating movement) is caused to move upward from the state in FIG. 11. FIG. 13 is a schematic cross-sectional view of the injection apparatus illustrating a state in which the melter is caused to move downward from the state in FIG. 12 and molten resin is ejected to the outside from the nozzle part.

In FIG. 11 to FIG. 13, parts identical to those in FIG. 6 to FIG. 8 are assigned identical reference numerals. As shown in FIG. 11, the melter 3 and the drive section 8 are connected together via the drive transmission shaft 9. As shown in FIG. 11, a closing member 40 is provided closer to the rear end 2b side of the cylinder 2 than the melter 3. The planar area of the closing member 40 coincides with the planar area of the space surrounded by the inner wall surface in the cylinder 2. The closing member 40 is fixed in the cylinder 2.

As shown in FIG. 11, the drive transmission shaft 9 penetrates the closing member 40 and is connected to the melter 3. As shown in FIG. 11, the drive transmission shaft 9 penetrates the melter 3 at its center, and the melter 3 and the drive transmission shaft 9 are fixed and connected together.

As shown in FIG. 11, an opening/closing member 41 is provided on the undersurface (outflow port surface) 3b side of the melter 3. The opening/closing member 41 is supported so as to close or release the outflow port of each through hole 10 of the melter 3 based on vertical movement of the melter 3. The opening/closing member 41 is always urged toward the undersurface (outflow port surface) of the melter 3 using, for example, an elastic member (not shown). Operations of the drive section 8 and the drive transmission shaft 9 can release the opening/closing member 41 from the undersurface 3b of the melter 3.

The opening/closing member 41 is formed with an area smaller than that of the melter 3. A through hole may also be formed in the opening/closing member 41. In this case, the position and size of the through hole formed in the opening/closing member 41 are restricted so as not to overlap those of the outflow port 10b of each through hole 10 of the melter 3.

As shown in FIG. 11, the melter 3 is located on the distal end 2a side of the cylinder 2 and in an initial state in FIG. 11, many solid resin pellets (injection material) P are supplied into the cylinder 2 from the storage part 18 via the supply pipe 12.

The resin pellets P are introduced into each through hole (melting hole) 10 of the melter 3 from the inflow port (top surface in the drawing). The resin pellets P introduced into each through hole 10 are pressed toward the outflow port side of each through hole 10 (undersurface side in the drawing) by resin pellets P that are introduced later. In this case, the melter 3 is kept at a temperature at which the resin pellets P are melted via the heating means 6.

As shown in FIG. 11, the resin pellets P that have flown into each through hole 10 are partially softened by heat from the melter 3.

Next, as shown in FIG. 12, drive means is driven to drive the melter 3 toward the direction of the closing member 40 (upward direction in the drawing) (melting step). This causes all the many resin pellets P located between the inflow port side face of the melter 3 (top surface in the drawing) and the undersurface of the closing member 40 to be pressed against each other.

As shown in FIG. 12, although the heating means 6 is fixed to the outer circumference of the cylinder 2, even when the melter 3 is caused to move to and fro in the vertical direction by the drive means, the melter 3 can be configured to keep the heat source sufficiently in terms of the heat capacity of the melter 3. Note that a heat-insulating structure is preferably provided between the melter 3 and the drive transmission shaft 9 so as to prevent heat of the melter 3 from transmitting to the drive transmission shaft 9.

The resin pellets P charged into each through hole (melting hole) 10 of the melter 3 are heated and pressurized while being kept airtight, and thus caused to start melting. In this case, the opening/closing member 41 located on the undersurface (outflow port) 3b side of the melter 3 is released from the melter 3. In this way, molten resin q that has flown downward from the melter 3 remains between the melter 3 and the nozzle part 4.

Next, in FIG. 13, the drive means is operated to cause the melter 3 to move toward the direction of the nozzle part 4 (downward in the drawing) (injection step). In this case, the opening/closing member 41 is in contact with the undersurface 3b of the melter 3, closing the outflow port 10b of each through hole 10 of the melter 3. Thus, molten resin q remaining between the melter 3 and the nozzle part 4 is pressurized while being kept airtight and ejected from the nozzle part 4. The molten resin q is injected between the upper mold 27 and the lower mold 28 that constitute a molding die. As shown in FIG. 13, a conductive joined body 62 obtained by electrically connecting a plurality of conductive members is disposed in advance, surroundings of the conductive joined body 62 can be filled with a resin molded body 64 through the injection of the molten resin q, and this makes it possible to secure electrical insulating properties of the connection part 63 of the conductive joined body 62 from the outside.

Using the melter 3 in which the opening width T1 of the inflow port 10a shown in FIG. 9 is 4.1 mm to 10 mm and the opening width T2 of the outflow port 10b is 1.0 mm to 4.5 mm or using the melter 3 in which the inflow port 10a side of each through hole 10 shown in FIG. 10 is formed of a gentle inclined surface, the injection apparatus shown in FIG. 11 to FIG. 13 can also improve melting efficiency more effectively compared to the prior arts.

Using the injection apparatus shown in FIG. 6 to FIG. 13, it is possible to increase melting efficiency and obtain a resin molded body without applying a large pressure. Especially, it is possible to reduce the size of the metal die and obtain a small resin molded body. Using the injection apparatus shown in FIG. 6 to FIG. 13, it is possible to easily obtain a resin molded body in which a first phase accounts for 50% or more which is observed within a measurement range of 5 μm×5 μm arbitrarily selected on a resin cross section and in which convex and concave parts extend in a substantially linear direction. However, the injection molded body according to the present embodiment may also be manufactured using any injection apparatus other than the injection apparatus shown in FIG. 6 to FIG. 13 as long as the first phase satisfies the requirement of accounting for 50% or more of the measurement range.

### EXAMPLES

Hereinafter, the present invention will be described in detail according to examples and comparative examples which have been conducted to clarify the effects of the present invention. It should be noted, however, that the present invention is by no means limited by the following examples.

Although the state of material of a resin cross section of each resin molded body is analyzed hereinafter using a plurality of examples and comparative examples, parts such as traces of a blade when cutting is done are also found in photographs of resin cross sections. For obvious traces of a blade, analyses can be made within a region except the traces of the blade. Alternatively, when it is unknown whether or not such parts are traces of the blade, analyses are made by excluding the unknown region.

### Example 1

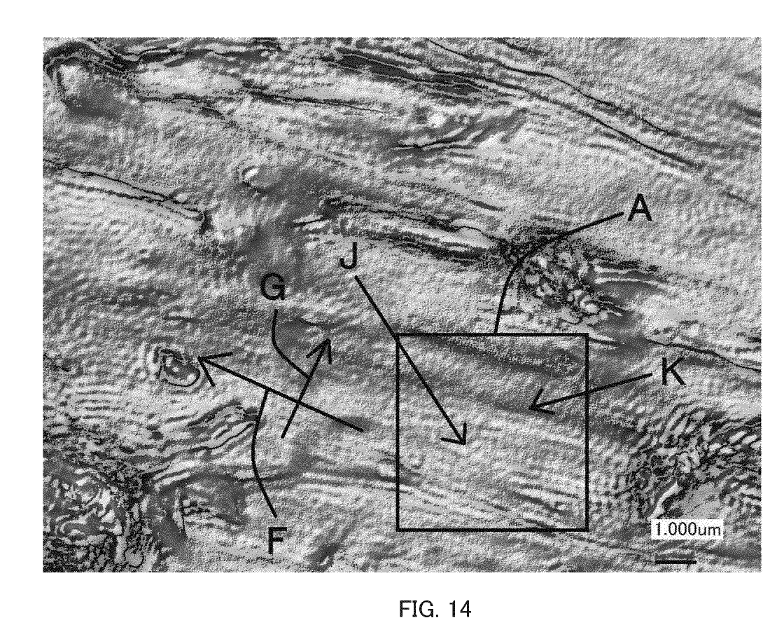

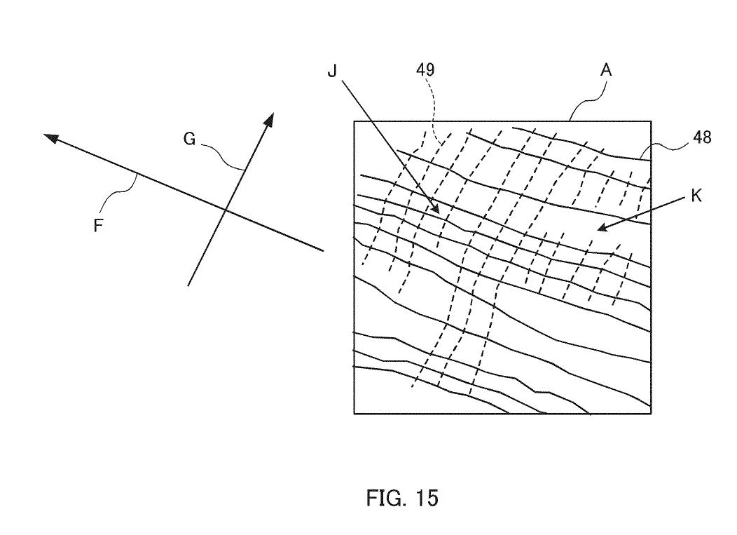

A resin molded body was obtained using polypropylene (PP) as the resin pellets (injection material) P and using the injection apparatus shown in FIG. 6 to FIG. 8 and the melter shown in FIG. 10. The resin molded body obtained was cut substantially at the center using a cutting machine and images of the substantially central region of the cut cross section were picked up using a laser microscope. A laser microscope VX-250 manufactured by Keyence Corporation was used as the laser microscope. FIG. 14 is a laser micrograph of example 1 picked up at a magnification of 15000×.

The measurement range A of 5 μm×5 μm was arbitrarily selected from within the laser micrograph shown in FIG. 14. FIG. 15 is a schematic view within the measurement range A shown in FIG. 14. As shown in FIG. 14 and FIG. 15, a first phase J in which convex and concave parts extend in a substantially linear direction F was observed in the measurement range A. A solid line 48 shown in FIG. 15 indicates either a convex part or a concave part. Furthermore, as shown in FIG. 14 and FIG. 15, a first phase in which convex and concave parts extend in a substantially linear direction G is also observed in the measurement range. A dotted line 49 shown in FIG. 15 indicates either a convex part or a concave part. That is, the first phase in example 1 is a region in which convex and concave parts extend in the substantially linear direction F or the substantially linear direction G or in the substantially linear directions F and G. In this way, it has been appreciated that regularly arrayed regions were observed in the measurement range of 5 μm×5 μm and high polymers are crystallized.

As shown in FIG. 14 and FIG. 15, the measurement range also includes regions where it is unknown whether or not such regions constitute the first phase, and such regions are guessed to be an amorphous phase (amorphous phase; second phase) K. The amorphous phase K is interposed between the first phases.

It has been found in example 1 shown in FIG. 14 and FIG. 15 that the first phases in which convex and concave parts extend in the substantially linear direction account for approximately 70% or more.

### Comparative Example 1

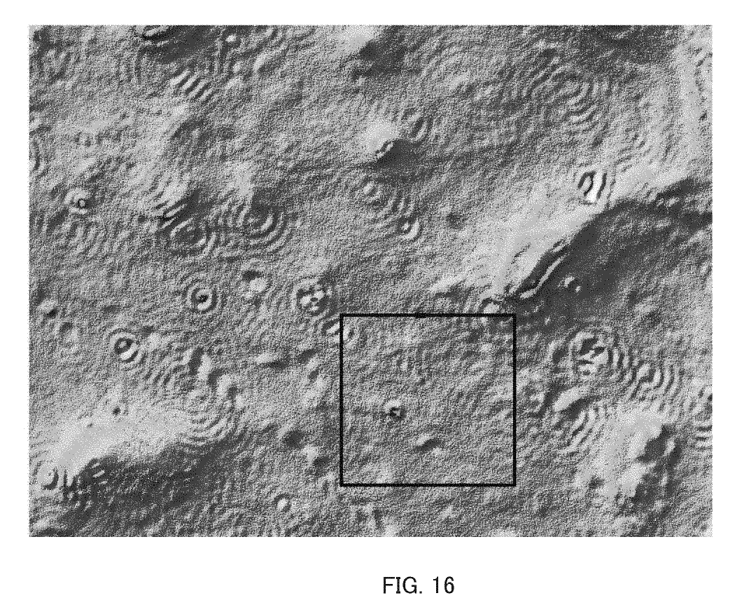

A molded body available on the market and manufactured using a conventional injection apparatus (molding machine) was used. The material of the molded body was mainly polypropylene (PP). The product available on the market was cut substantially at the center using a cutting machine and images of a substantially central part of the cutting cross section were picked up using a laser microscope. The laser microscope used is similar to that in example 1. FIG. 16 is a laser micrograph of comparative example 1 picked up at a magnification of 15000×.

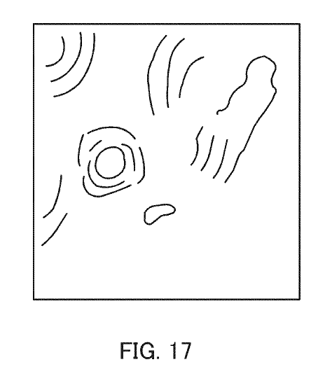

As shown in FIG. 16, the measurement range of 5 μm×5 μm was arbitrarily selected from within the laser micrograph. FIG. 17 is a schematic view within the measurement range shown in FIG. 16. As shown in FIG. 16 and FIG. 17, it has been found that the proportion of the first phase in which convex and concave parts extend in the substantially linear direction within the measurement range is small. Furthermore, spiral patterns with concentric circles were observed, which was presumably caused by the filler.

In this way, it has been found from a comparison between example 1 in FIG. 14 and FIG. 15 and comparative example 1 in FIG. 16 and FIG. 17, that the two are obviously different in the state of material of the resin cross section. That is, the crystal structure was observed within the measurement range in example 1, whereas no clear crystal structure was observed in comparative example 1.

When the respective resin molded bodies in example 1 and comparative example 1 were cut, it has been found that example 1 required a stronger force for cutting than comparative example 1, exhibiting higher cutting strength.

### Example 2 and Comparative Example 2

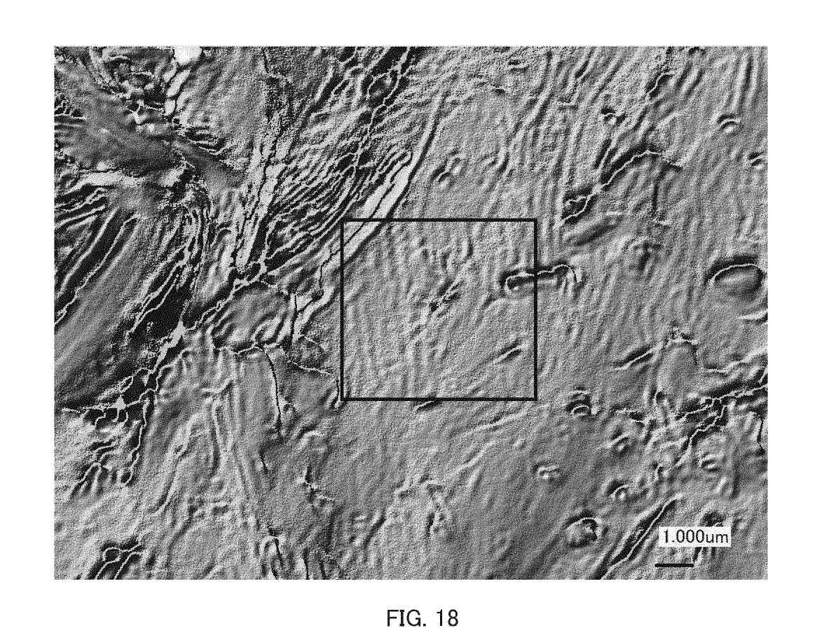

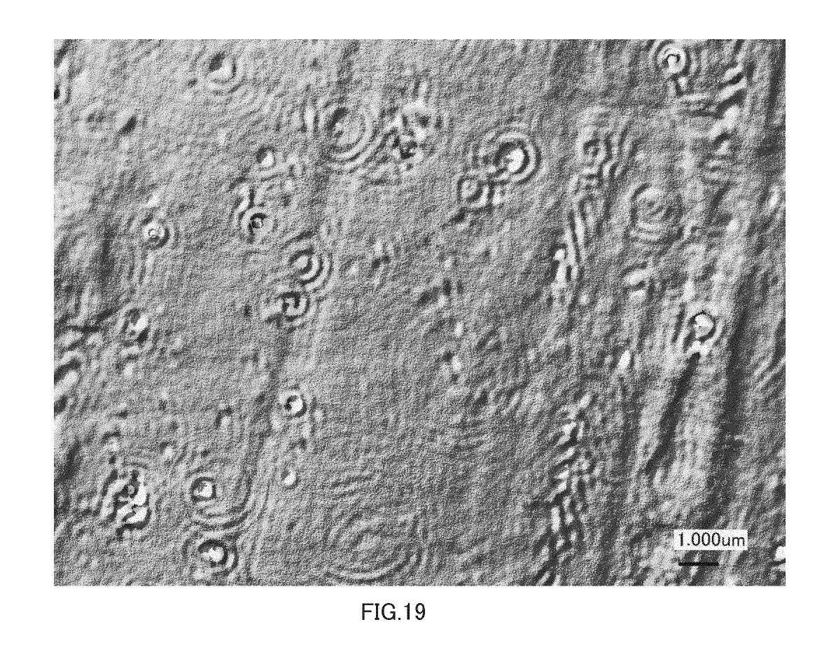

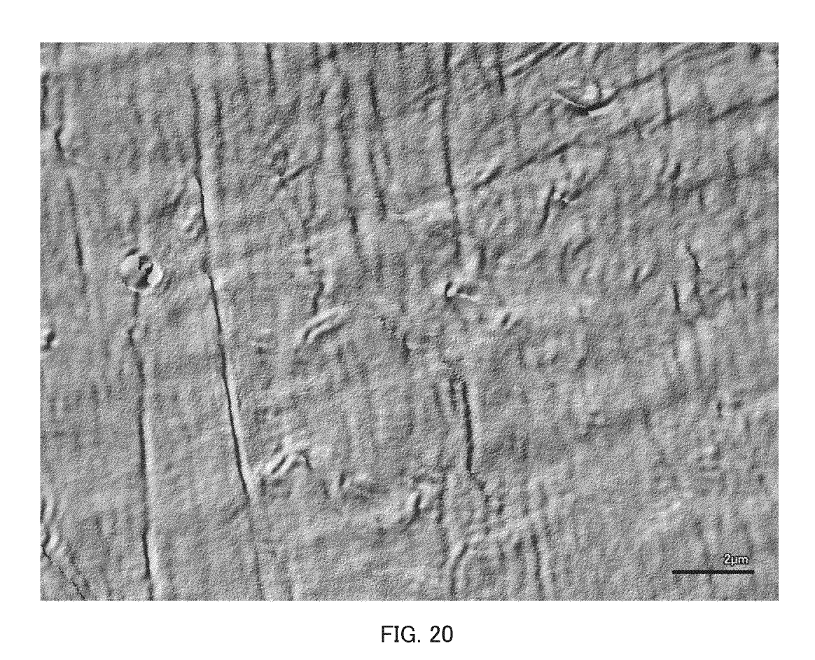

FIG. 18 is a laser micrograph of example 2 and FIG. 19 is a laser micrograph of comparative example 2. Both FIG. 18 and FIG. 19 are photographs of end regions of resin cross sections (see the end region B in the lower drawing of FIG. 4). Note that FIG. 18 and FIG. 19 are laser micrographs of example 2 and comparative example 2 respectively picked up at a magnification of 15000×.

It has been found from a comparison between example 2 in FIG. 18 and comparative example 2 in FIG. 19, that both are obviously different in the state of material of resin cross sections. In example 2 in FIG. 18, a first phase in which convex and concave parts extend in the substantially linear direction is observed within the measurement range, whereas in comparative example 2 in FIG. 19, almost no first phase is observed or it is unknown whether or not the first phase exists. Furthermore, in comparative example 2, spiral patterns with concentric circles are observed. In example 2 in FIG. 18, it has been found that the area ratio of the first phase to the measurement range of 5 μm×5 μm accounts for 50% or more.

However, it has been found from a comparison between example 1 in FIG. 14 and example 2 in FIG. 18, that it was possible to more clearly distinguish the first phase in which convex and concave parts extend in the substantially linear direction in example 1 in which the resin cross section was observed substantially at the center than in example 2 in which the resin cross section was observed in the vicinity of the end portion. Moreover, it has also been found that the first phase occupied a wider area in example 1 than in example 2. This is because the end portion of the resin cross section was more susceptible to external influences or the like than the internal portion and crystallization was promoted more in the inside of the resin molded body than at the end portion, and therefore it has been found that it is preferable to measure the state of material in the inside region except the end region of the resin cross section, and do so substantially at the center of the resin cross section in particular.

### Example 3

Aside from example 1, a resin molded body was obtained using polypropylene (PP) as the resin pellets (injection material) P and using the injection apparatus shown in FIG. 6 to FIG. 8 and the melter shown in FIG. 10. The resin molded body obtained was cut substantially at the center using a cutting machine and images of a substantially central part of the cutting cross section were picked up using a laser microscope. The laser microscope used is similar to that in example 1. FIG. 20 is a laser micrograph of example 3 picked up at a magnification of 15000×.

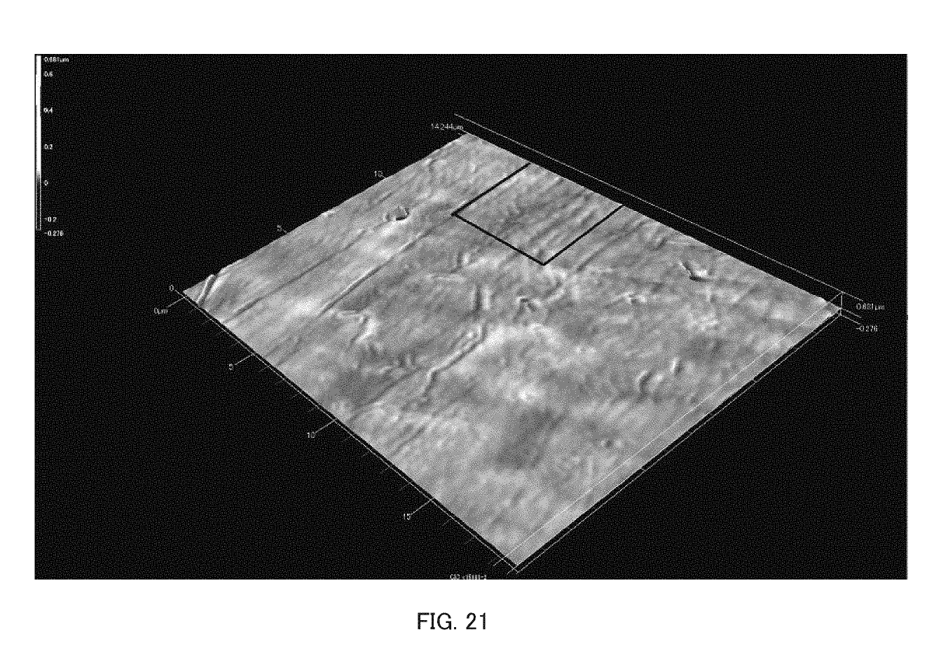

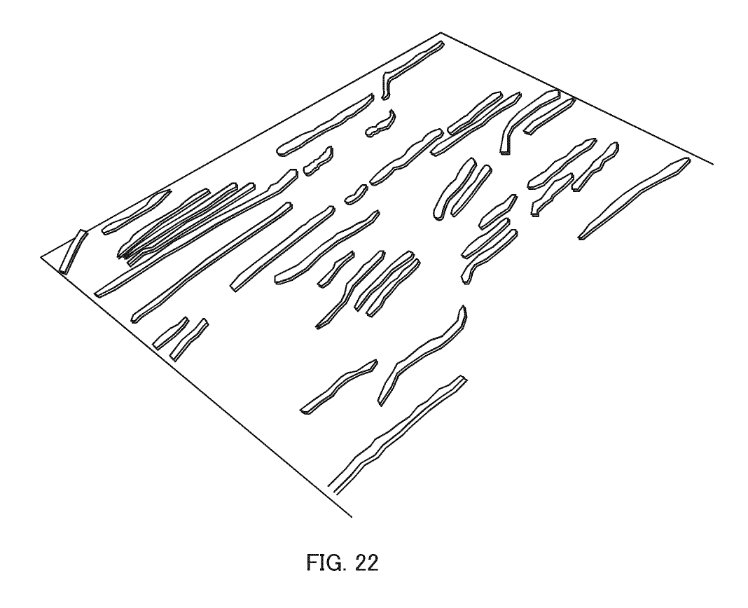

FIG. 21 is a 3D photograph of the laser micrograph in FIG. 20. Furthermore, FIG. 22 is a partial schematic view illustrating part of the 3D photograph shown in FIG. 21.

As shown in FIG. 21 and FIG. 22, it has been found that a plurality of convex parts existed in the resin cross section. In the laser micrograph corresponding to a plan view of the resin cross section in FIG. 20, a plurality of stripe-shaped shadows were reflected and such parts were guessed to constitute convex parts or concave parts, but it has been found with the 3D photograph in FIG. 21 that convex and concave parts existed in the resin cross section.

Note that the partial schematic view in FIG. 22 illustrates convex parts having a height of approximately 0.15 μm or more but does not illustrate those having a smaller height. Therefore, although there are actually more convex parts than those illustrated in FIG. 22, convex parts having a smaller height are omitted from the drawing.

As shown in FIG. 22, it has been found that many convex parts were formed extending in a substantially linear direction. Since a concave part was configured between convex parts, concave parts as well as convex parts extended in the substantially linear direction in the like manner, and therefore it has been found that the plurality of convex parts extending in the substantially linear direction shown in FIG. 22 including concave parts on both sides thereof constituted regularly arrayed first phases. As described above, FIG. 22 illustrates only high, outstanding convex parts and it has been found that if low, apparently blurred convex parts were included, there existed first phases in which convex and concave parts extended in the substantially linear direction over a wide range of the measurement region. It has been found that the ratio of the first phases to the measurement range of 5 μm×5 μm enclosed by the square in FIG. 21 was approximately 60%.

### Comparative Example 3

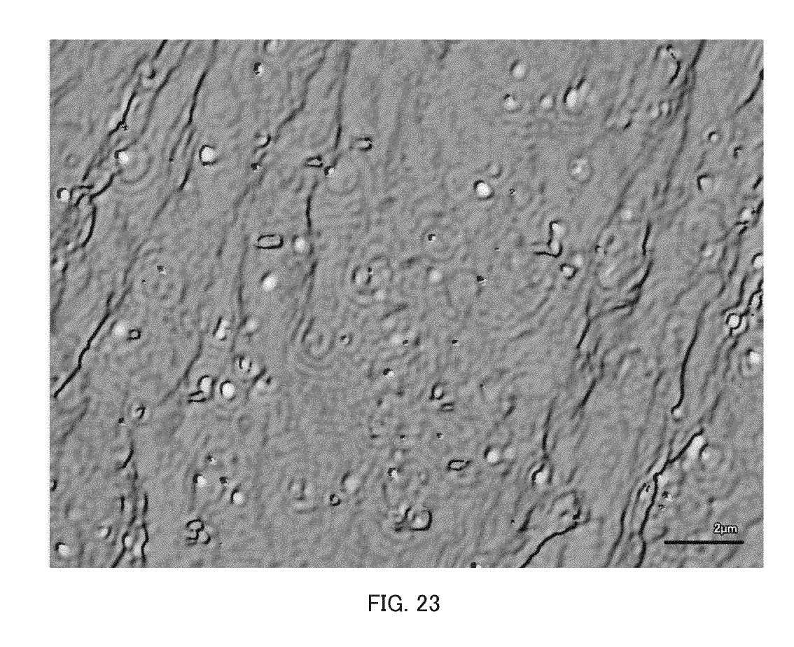

A molded body available on the market was used which was separate from comparative example 1 and manufactured using a conventional injection apparatus (molding machine). The material of the molded body was mainly polypropylene (PP). The product available on the market was cut substantially at the center using a cutting machine and images of the substantially central region of the cut cross section were picked up using a laser microscope. The laser microscope used is similar to that used in example 1. FIG. 23 is a laser micrograph of comparative example 1 picked up at a magnification of 15000×.

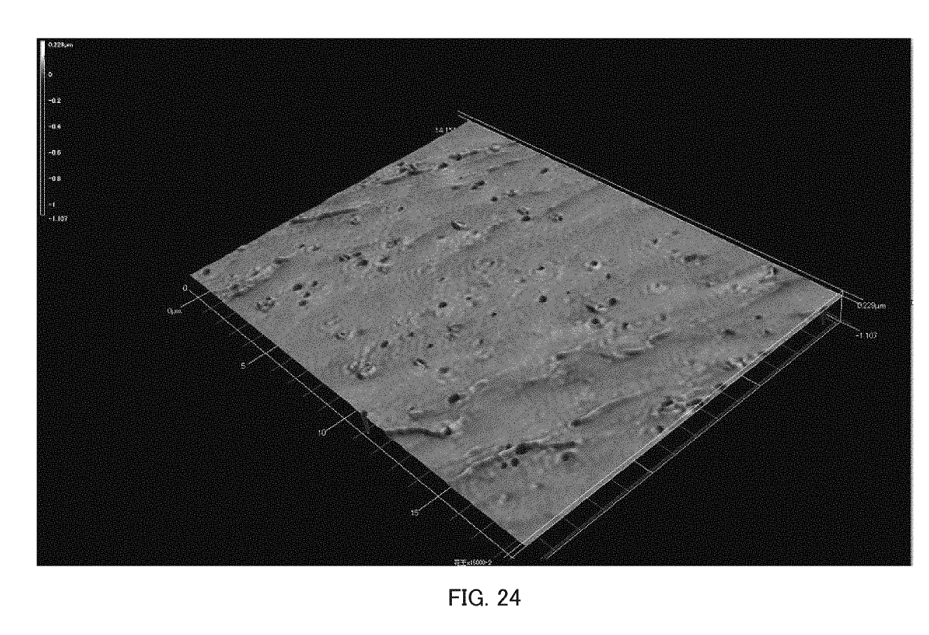

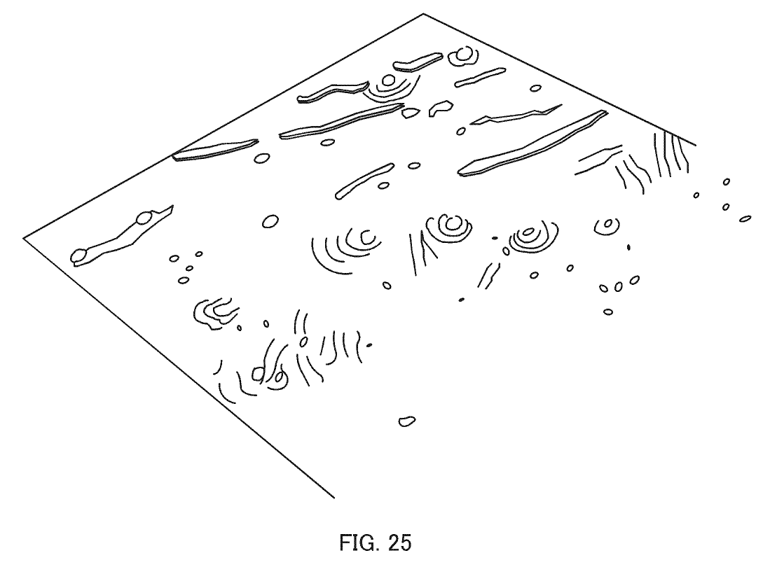

FIG. 24 is a 3D photograph of the laser micrograph in FIG. 23. FIG. 25 is a partial schematic view illustrating part of the 3D photograph shown in FIG. 24.

As shown in FIG. 24 and FIG. 25, though a plurality of convex parts existed in the resin cross section, fewer convex parts extended in a substantially linear direction unlike example 3 and some convex parts were twisted and turned, and spiral patterns with concentric circles are observed in many convex parts, which was presumably caused by the filler.

Thus, it has been found that the ratio of the first phases in comparative example 3 was lower than that in example 3 and there was no region in which the first phases accounted for 50% or more within the measurement range of 5 μm×5 μm. From above, it has been verified from the 3D photograph that example 3 had a wider range of regularly arrayed first phases than comparative example 3 and that there was a wide range of region where high polymers were regularly arranged in a crystalline state.

Although 3D photographs were applied only to example 3 and comparative example 3, since other examples and comparative examples also provided laser micrographs similar to those in example 3 and comparative example 3, it was possible to verify that stripe-shaped parts seen in each laser micrograph were convex and concave parts and it has been thereby found in this example that the ratio of the first phases to the arbitrarily selected measurement range of 5 μm×5 μm was at least 50%.

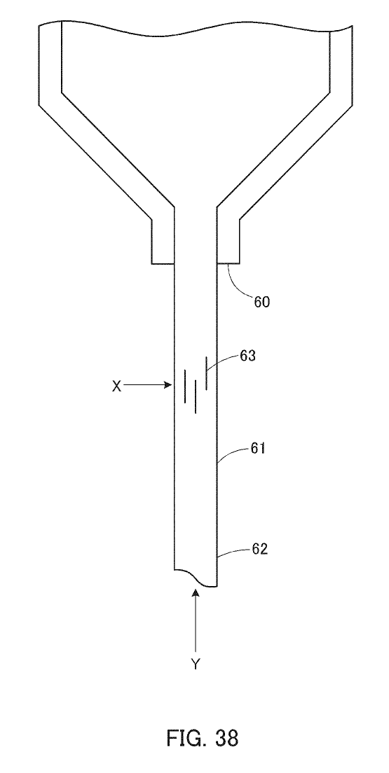

Next, a resin molded body obtained by mixing a filler with resin was observed. Polyacetal (POM) was used as the resin and a glass fiber was used as the filler. Note that the content of the glass fiber accounted for 25%. In the experiment, as shown in FIG. 38, a solidified, long resin molded body 62 was observed without passing filler containing resin 61 ejected from the nozzle part 60 of the injection apparatus through the metal die. In the experiment, images of the surface of the resin molded body 62 obtained were picked up and observed at a magnification of 100× using a laser microscope VX-250 manufactured by Keyence Corporation.

### Comparative Example 4

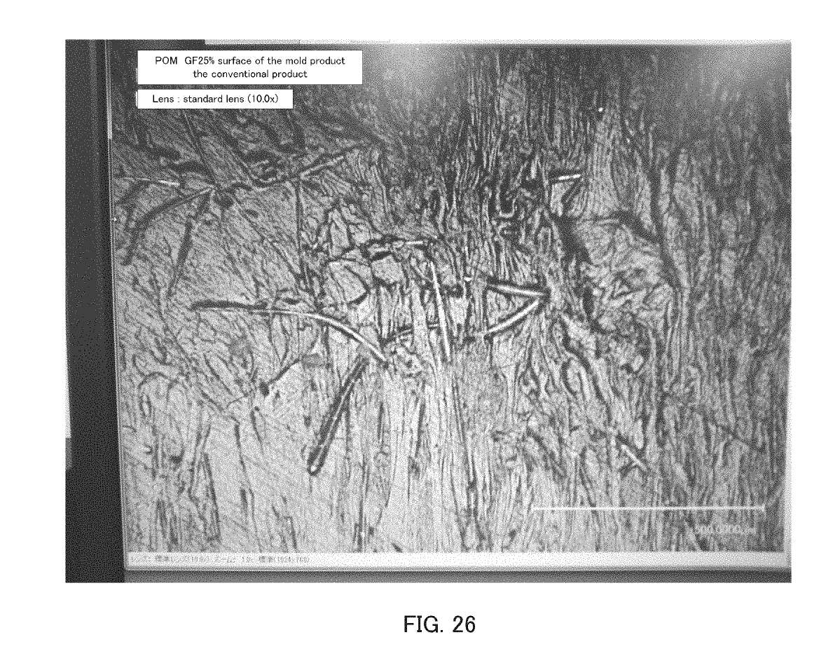

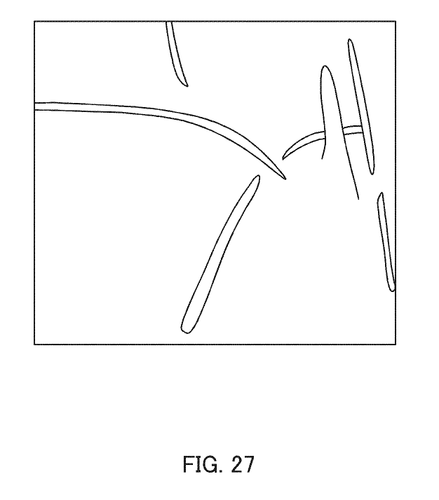

A resin molded body of comparative example 4 was obtained using a conventional injection apparatus (molding machine). As a conventional injection apparatus, Model: Si-50-6 (screw φ is 24, theoretical output performance is 43 cc) manufactured by Toyo Machinery & Metal Co., Ltd. was used. FIG. 26 is a laser micrograph of a surface of a molded body of comparative example 4. FIG. 27 is a schematic view illustrating part of FIG. 26.

An arbitrarily selected measurement range of 500 μm×500 μm shown in FIG. 26 was observed and presented in FIG. 27 as a schematic view. As shown in FIG. 26 and FIG. 27, a plurality of glass fibers were observed in the measurement range, and some of the glass fibers were observed as being cut to smaller sizes or bent.

### Example 4

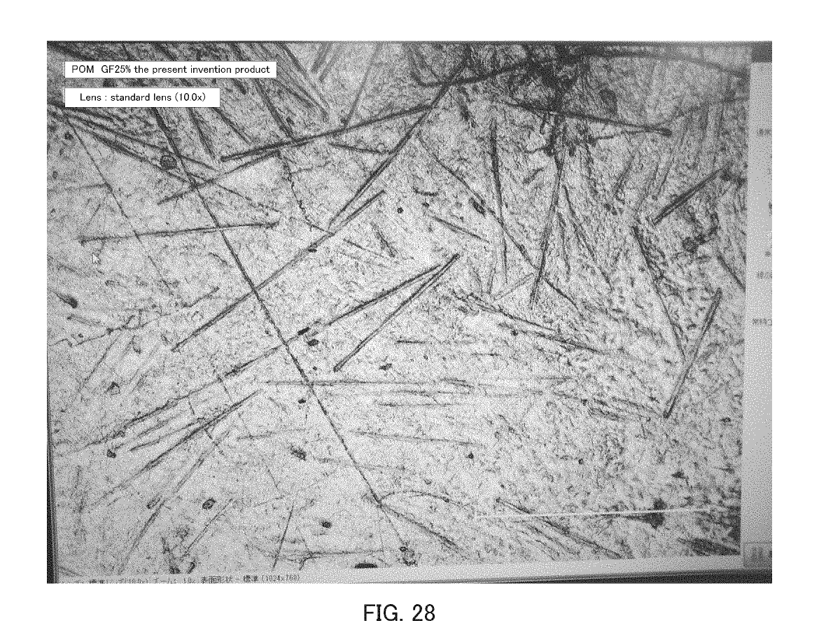

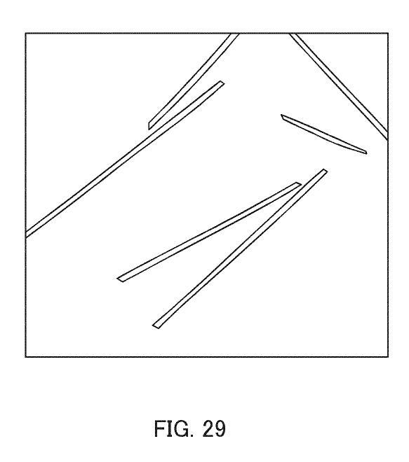

A resin molded body was obtained using the injection apparatus shown in FIG. 6 to FIG. 8 and the melter shown in FIG. 10. FIG. 28 is a laser micrograph of a surface of the molded body of example 4. FIG. 29 is a schematic view illustrating part of FIG. 28.

The arbitrarily selected measurement range of 500 μm×500 μm shown in FIG. 28 was observed and presented in FIG. 29 as a schematic view. As shown in FIG. 28 and FIG. 29, a plurality of glass fibers were observed within the measurement range and it has been found that the glass fibers appeared in a long linear shape compared to comparative example 4. Regarding a preferable range of lengths of glass fibers included in the resin molded body, it is preferable to keep 5% or more of the lengths of glass fibers contained in pellets. An upper limit value is not particularly limited, but it is, for example, 10% or less.

In the present example, it is possible to reduce the number of fillers which are cut to a smaller length compared to the resin molded body molded using the conventional injection apparatus. An average length of fillers observed in the arbitrarily selected measurement range of 500 μm×500 μm in the present example can be greater than in the prior art. Therefore, in the present example, longer fillers appear on the surface than the prior art.

As shown in FIG. 28 and FIG. 29, no bent glass fibers in comparative example 4 were observed in example 4.

In the present example, 50% or more of the plurality of fillers observed within the arbitrarily selected measurement range of 500 μm×500 μm preferably have a long linear shape and more preferably 80% or more of the filters have such a shape.

In the case of the conventional injection apparatus, it is considered that the fillers are cut by the screw in the molding machine or bent. On the other hand, with the injection apparatus in the present example, unlike the conventional injection apparatus, there is no cutting by the screw, fillers are not fragmented even when some fillers may be cut, and it is therefore possible to keep large filler lengths and mix fillers having excellent long linearity with the molded body. In the present example, when it is assumed that the length of a straight line connecting both ends of a filler is L1 and the distance of an orthogonal line orthogonal to the straight line from the straight line to the filler is L2, if L2/L1 is 0.05 or less or preferably 0.02 or less, such a filter can be said to be a filler with excellent linearity.

The fillers appearing on the surface of the resin molded body were observed above, and next, fillers existing inside the resin molded body were observed.

In the experiment, the resin molded body 62 obtained in FIG. 38 were cut in a resin flow direction Y and the cut surface (longitudinal cross section) was observed. That is, the resin molded body 62 was not cut from the horizontal direction X orthogonal to the resin flow direction. This is because since fillers 63 were guessed to be arranged uniformly in the resin flow direction (injection direction), if the fillers 63 were cut in the horizontal direction X, only minimum cross sections obtained by cutting the fillers 63 in the width direction would appear, and it was not possible to appropriately observe states of the fillers 63 inside the resin.

In an experiment on the longitudinal cross section of the following resin molded body, polyphenylene sulfide (PPS) was used as the resin and a raw material manufactured by Lion Idemitsu Composites Co., Ltd. containing carbon fibers was used as the filler. In the experiment, the surface of the resin molded body 62 obtained was observed using a laser microscope VX-250 manufactured by Keyence Corporation.

### Comparative Example 5

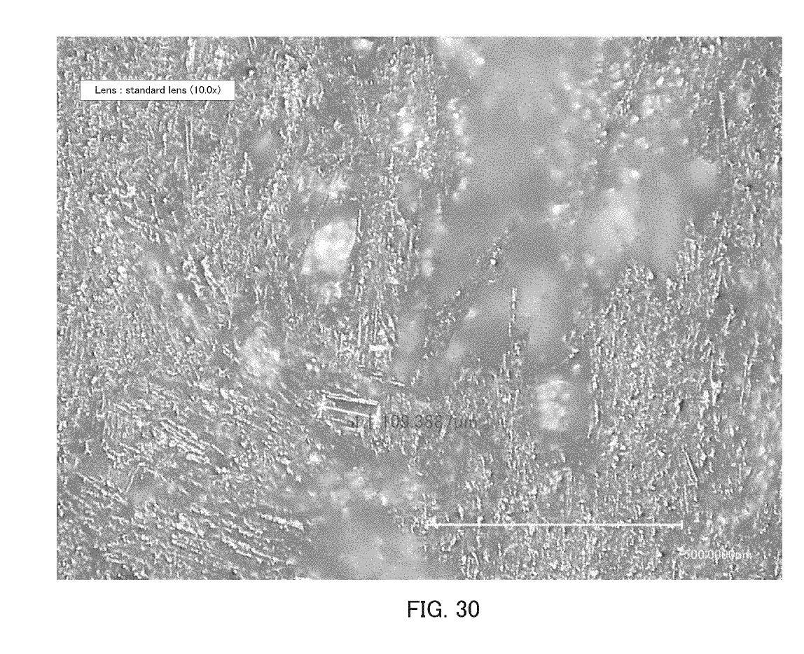

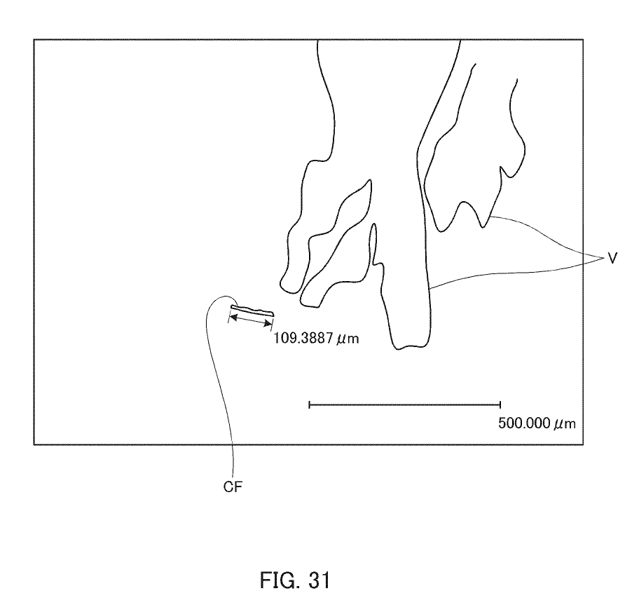

A resin molded body of comparative example 5 was obtained using a conventional injection apparatus (molding machine). As a conventional injection apparatus, Model: Si-50-6 (screw φ is 24, theoretical output performance is 43 cc) manufactured by Toyo Machinery & Metal Co., Ltd. was used. FIG. 30 is a laser micrograph of a longitudinal cross section of comparative example 5. FIG. 31 is a schematic view illustrating part of FIG. 30.

As shown in FIG. 30 and FIG. 31, occurrences of voids V were observed on a cross section of comparative example 5. A carbon fiber CF had a length of on the order of 100 μm. This is approximately 1/50 to 1/60 of the length in a pellet state. The plurality of carbon fibers CF are oriented randomly.

### Comparative Example 6

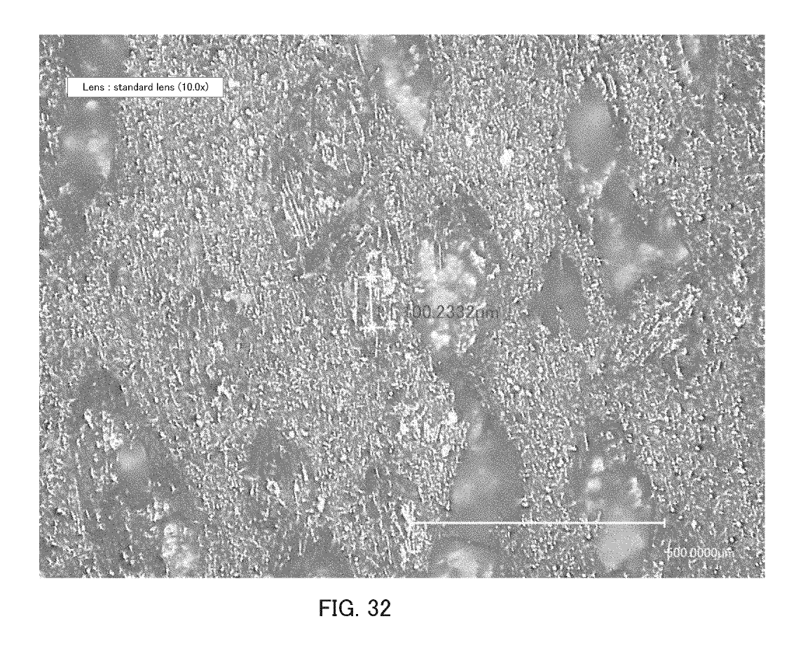

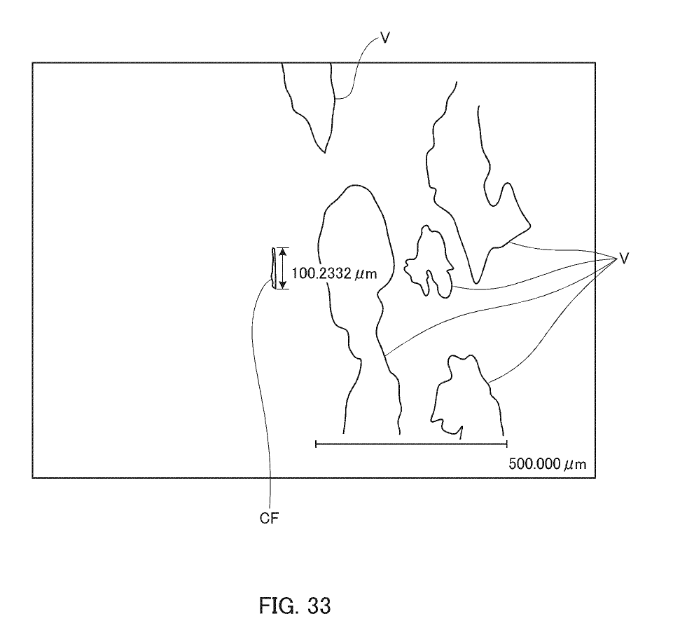

FIG. 32 is a laser micrograph of a longitudinal cross section of comparative example 6. FIG. 33 is a schematic view illustrating part of FIG. 32. FIG. 32 shows a longitudinal cross section cut at a place different from FIG. 30.

In comparative example 6 just like comparative example 5, occurrences of voids V were observed on the cross section. Furthermore, a carbon fiber VF also had a length on the order of 100 μm which was not different from comparative example 5.

### Example 5

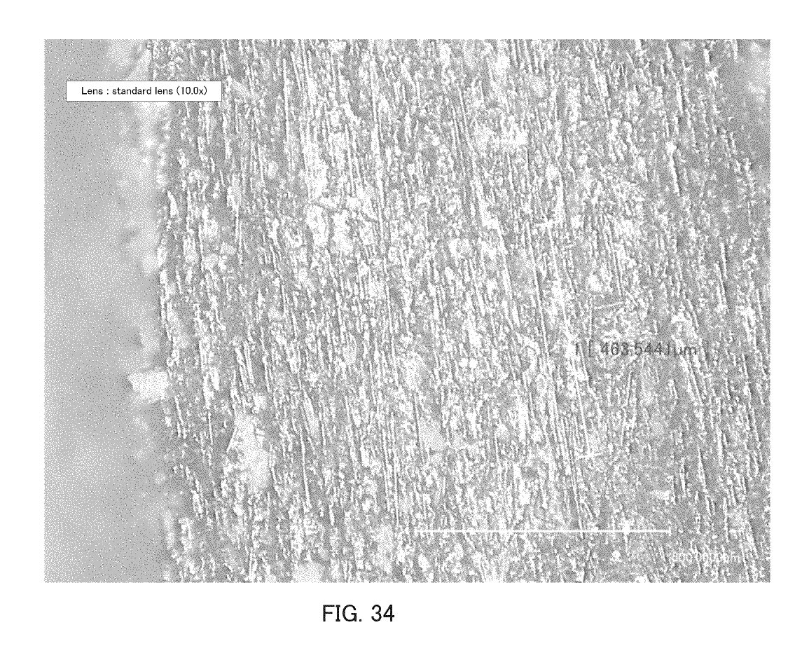

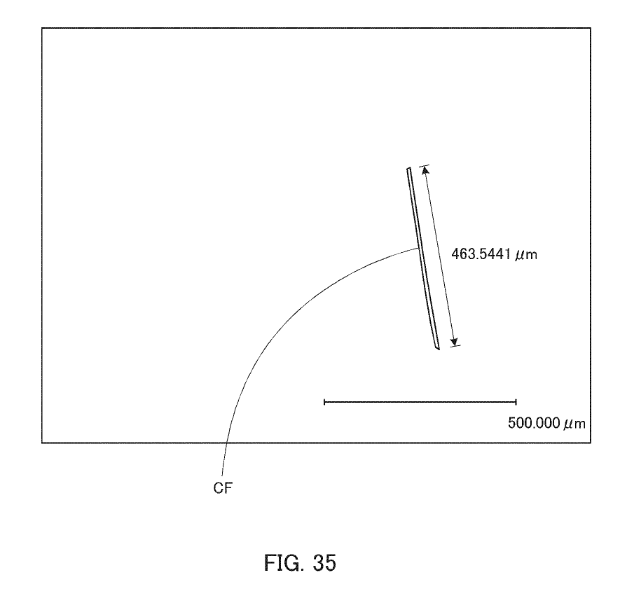

A resin molded body was obtained using the injection apparatus shown in FIG. 6 to FIG. 8 and the melter shown in FIG. 10. FIG. 34 is a laser micrograph of a longitudinal cross section of example 5. FIG. 35 is a schematic view illustrating part of FIG. 34.

As shown in FIG. 34 and FIG. 35, no occurrence of voids V was observed unlike comparative example 5 and comparative example 6. Furthermore, the carbon fiber CF had a length on the order of 500 μm and it has been found that longer carbon fibers CF than comparative example 5 and comparative example 6 were left.

### Example 6

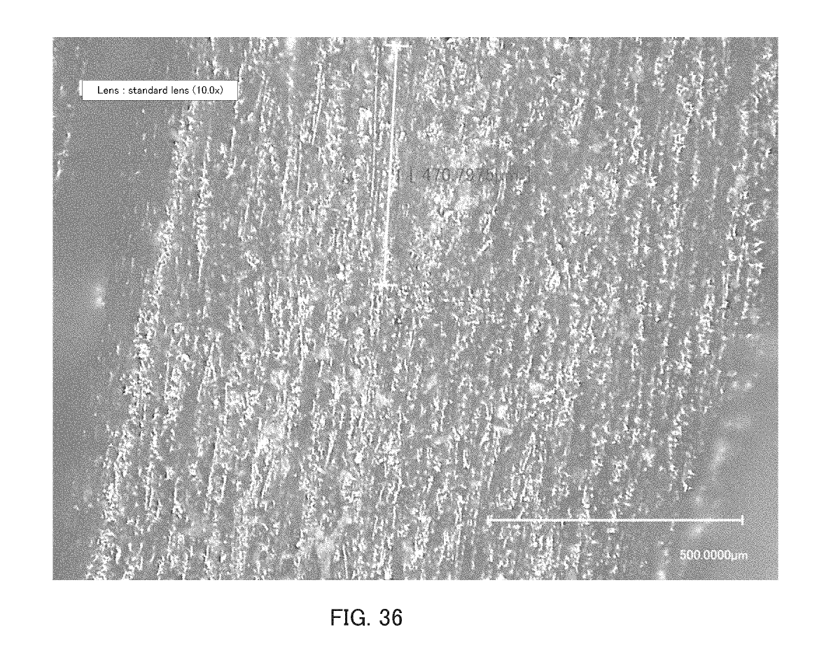

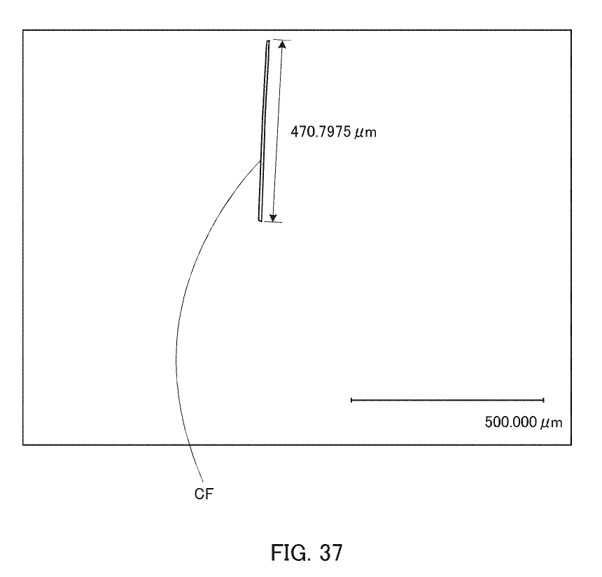

FIG. 36 is a laser micrograph of a longitudinal cross section of example 6. FIG. 37 is a schematic view illustrating part of FIG. 36. FIG. 36 is a longitudinal cross section cut at a place different from FIG. 34.

In example 6 just like example 5, occurrences of voids V were not observed on the cross section. Furthermore, the carbon fiber CF also had a length on the order of 500 μm as in the case of example 5.

The reason for the occurrences of voids V in comparative example 5 and comparative example 6 was considered that the interior of the cylinder of the conventional injection apparatus had an atmospheric pressure, decomposed gas was generated and kneaded with resin together with air when the resin was heated.

In comparative example 5 and comparative example 6, carbon fibers

CF were cut into pieces on the order of 100 μm but this is considered to be attributable to the fact that carbon fibers were cut to small sizes by the screw in the molding machine just like comparative example 4.

In contrast, no void was observed on the cross section in example 5 and example 6. This is because with the injection apparatus in the present example, resin is melted in a pressurized, hermetically sealed state, and therefore degassing from resin is suppressed and is not kneaded with air. In the present example, voids need not be compressed and a high quality resin molded body can be formed even under a low injection pressure.

It has been found that the length of the carbon fibers observed in example 5 and example 6 was relatively long such as approximately 500 μm and respective carbon fibers were generally uniformly oriented.

From above, the filler-containing resin molded body is considered to have a greater strength increasing effect using fillers in the present example than in the comparative example.

### INDUSTRIAL APPLICABILITY

The present invention can provide a resin molded body in which the states of material are regularly arrayed and the degree of crystallinity is high. Thus, when, for example, the resin molded body is used as a joined body of different members, the joined body having high joining strength can be attained.

The present application is based on Japanese Patent Application No. 2014-246628 filed on Dec. 5, 2014, entire content of which is expressly incorporated by reference herein.

1. A resin molded body comprising first phases in which convex and concave parts extend in a substantially linear direction, observed within a measurement range of 5 μm×5 μm arbitrarily selected on a resin cross section, wherein the first phases account for 50% or more.

2. The resin molded body according to claim 1, wherein the first phases account for 70% or more.

3. The resin molded body according to claim 1, wherein the first phases are in a crystalline state.

4. The resin molded body according to claim 1, wherein a second phase made of an amorphous substance is interposed between the first phases.

5. The resin molded body according to claim 1, wherein the measurement range is set substantially at a center of the resin cross section.

6. A resin molded body comprising resin and a filler, wherein the filler in a long linear shape is observed within a measurement range of 500 μm×500 μm arbitrarily selected on a resin surface or on a resin cross section.

7. The resin molded body according to claim 1, wherein the resin cross section is observed using a laser microscope.

8. The resin molded body according to claim 1, wherein the resin molded body is molded by an injection apparatus that incorporates a melter that includes a through hole, one opening of which is an inflow port of the injection material, the other opening of which is an outflow port of the injection material, and an inner wall surface of the through hole is formed of an inclined surface so that the opening becomes narrower from the inflow port to the outflow port of the through hole.

9. The resin molded body according to claim 8, wherein the resin molded body is molded by the injection apparatus that incorporates the melter in which an inclined surface which is continuous to the inclined surface and has a gentler slope than the inclined surface is formed on the inflow port side.
